(19) United States
(12) Patent Application Publication
(10) Pub. No.: US 2012/0300818 A1
(43) Pub. Date: Nov. 29, 2012

(54) SELF-CALIBRATION I/Q IMBALANCE REDUCTION

(75) Inventors: Leon Teruo Metreaud, Pepperell, MA (US); Hakan Inanoglu, Acton, MA (US)

(73) Assignee: QUALCOMM INCORPORATED, San Diego, CA (US)

(21) Appl. No.: 13/433,787

(22) Filed: Mar. 29, 2012

Related U.S. Application Data
(60) Provisional application No. 61/470,361, filed on Mar. 31, 2011.

(51) Int. Cl. H04B 15/00; H04W 24/00

(52) U.S. Cl. 375/219; 375/224

(57) ABSTRACT

A method for a self-calibrating reduction in inphase/quadrature imbalance is described. An inphase/quadrature amplitude imbalance is calculated. A correction to the inphase/quadrature amplitude imbalance is applied. An estimated inphase/quadrature phase imbalance is calculated. Calculating an estimated inphase/quadrature phase imbalance includes calculating a loopback phase. A correction to the estimated inphase/quadrature amplitude imbalance is applied.

### RELATED APPLICATIONS

This application is related to and claims priority from U.S. Provisional Patent Application Ser. No. 61/470,361, filed Mar. 31, 2011, for “DECOUPLED TX AND RX I/Q IMBALANCE SELF-CALIBRATION.”

### TECHNICAL FIELD

The present disclosure relates generally to wireless communication systems. More specifically, the present disclosure relates to systems and methods for self-calibration FQ imbalance reduction.

### BACKGROUND

Wireless communication systems are widely deployed to provide various types of communication content such as voice, video, data and so on. These systems may be multiple-access systems capable of supporting simultaneous communication of multiple mobile devices with one or more base stations.

A mobile device and a base station may each include a transmitter and a receiver to support bi-directional communication. The transmitter may condition and upconvert inphase (I) and quadrature (Q) output baseband signals with transmit local oscillator (LO) signals to obtain an output radio frequency (RF) signal that is more suitable for transmission via a wireless channel. The receiver may receive an input RF signal via the wireless channel and may downconvert the input RF signal with receive local oscillator (LO) signals to obtain inphase (I) and quadrature (Q) input baseband signals.

The transmitter and receiver may each include separate branches for the inphase (I) and quadrature (Q) signals. Ideally, the I branch and the Q branch have equal gain with a 90 phase difference from each other. However, imbalances may exist between the I branch and the Q branch. These imbalances may degrade the performance of the transmitter and the receiver. Benefits may be realized by improvements to the design and operation of I branches and Q branches.

### SUMMARY

A method for a self-calibrating reduction in inphase/quadrature imbalance is described. An inphase/quadrature amplitude imbalance is calculated. A correction to the inphase/quadrature amplitude imbalance is applied. An estimated inphase/quadrature phase imbalance is calculated. Calculating an estimated inphase/quadrature phase imbalance includes calculating a loopback phase. A correction to the estimated inphase/quadrature phase imbalance is applied.

The inphase/quadrature imbalance may be in a transmitter. The estimated inphase/quadrature phase imbalance may be an estimated Tx inphase/quadrature phase imbalance. Calculating an inphase/quadrature amplitude imbalance may include transmitting an inphase-only tone at a calibration frequency, capturing the inphase-only tone in Rx digital front end memory, transmitting a quadrature-only tone at the calibration frequency, capturing the quadrature-only tone in the Rx digital front end memory and calculating a ratio of a root mean square of a complex signal from the stored inphase-only tone and the stored quadrature-only tone to obtain the amplitude imbalance.

Amplitude compensation factors may be obtained using the amplitude imbalance. Applying a correction to the inphase/quadrature amplitude imbalance may include applying the amplitude compensation factors to signals in the transmitter. Calculating an estimated inphase/quadrature phase imbalance may also include applying a known phase imbalance.

Calculating an estimated inphase/quadrature phase imbalance may also include transmitting a complex tone at a calibration frequency, capturing the complex tone in Rx digital front end memory and calculating an inphase and quadrature difference term and an inphase and quadrature product term from the stored complex tone. The loopback phase may be calculated using the inphase and quadrature difference term and the inphase and quadrature product term. Calculating an estimated inphase/quadrature phase imbalance may also include normalizing the stored complex tone by calculating the root mean square of the stored complex tone.

Calculating an estimated inphase/quadrature phase imbalance may include determining that a sign of the estimated inphase/quadrature phase imbalance does not correspond to the known phase imbalance and flipping the sign of the estimated inphase/quadrature phase imbalance. Calculating an estimated inphase/quadrature phase imbalance may further include applying a known phase imbalance and calculating an estimated Tx inphase/quadrature phase imbalance as the inphase and quadrature product term normalized by the cosine of the loopback phase. Applying a correction to the estimated inphase/quadrature phase imbalance may include removing the known phase imbalance, obtaining phase compensation factors using the estimated Tx inphase/quadrature phase imbalance and removing the estimated Tx inphase/quadrature phase imbalance using the phase compensation factors. Removing the estimated inphase/quadrature phase imbalance using the phase compensation factors may include applying the phase compensation factors to signals in the transmitter.

Calculating an estimated inphase/quadrature phase imbalance may include transmitting a complex tone at a calibration frequency, capturing the complex tone in Rx digital front end memory, calculating a root mean square of an inphase signal and a root mean square of a quadrature signal and determining whether to adjust the loopback phase by determining whether a ratio of the root mean square of the inphase signal to the root mean square of the quadrature signal is equal to one. If the ratio of the root mean square of the inphase signal to the root mean square of the quadrature signal is not equal to one, calculating an estimated inphase/quadrature phase imbalance may also include applying a phase shift to adjust the loopback phase and recalculating the root mean square of the inphase signal and the root mean square of the quadrature signal.

Calculating an estimated inphase/quadrature phase imbalance may also include applying a known phase imbalance. If the ratio of the root mean square of the inphase signal to the root mean square of the quadrature signal is equal to one, calculating an estimated inphase/quadrature phase imbalance may include removing the known phase imbalance. Applying a correction to the estimated inphase/quadrature phase imbalance may include obtaining phase compensation factors using the estimated inphase/quadrature phase imbalance and removing the estimated inphase/quadrature phase imbalance using the phase compensation factors.

Removing the estimated inphase/quadrature phase imbalance using the phase compensation factors may include applying the phase compensation factors to signals in the transmitter.

The inphase/quadrature imbalance may be in a receiver. Calculating an inphase/quadrature amplitude imbalance may include transmitting a DC signal with a shifted local oscillator at a calibration frequency, capturing the DC signal with the shifted local oscillator in Rx digital front end memory and setting a ratio of a root mean square of a received inphase signal and a root mean square of a received quadrature signal as the amplitude imbalance. Calculating an inphase/quadrature amplitude imbalance may include obtaining amplitude compensation factors using the amplitude imbalance. Applying a correction to the estimated inphase/quadrature amplitude imbalance may include applying the amplitude compensation factors to signals in the receiver.

Calculating an estimated inphase/quadrature phase imbalance may include transmitting a DC signal with a shifted local oscillator at a calibration frequency, capturing the DC signal with the shifted local oscillator in Rx digital front end memory, normalizing an Rx inphase signal and an Rx quadrature signal by a root mean square of the inphase and quadrature signals, scaling the normalized Rx inphase signal and the normalized Rx quadrature signal by the square root of two and calculating the phase imbalance as the averaged product of the scaled normalized Rx inphase signal and the scaled normalized Rx quadrature signal.

Calculating an estimated inphase/quadrature phase imbalance may include obtaining phase compensation factors using the inphase/quadrature phase imbalance. Applying a correction to the inphase/quadrature phase imbalance may include applying the phase compensation factor to signals in the receiver.

The method may be performed by a digital processor in a wireless device. The wireless device may be a wireless communication device or a base station. The method may be self-calibrating within the wireless device. The inphase/quadrature imbalance may be estimated during warm-up while temperatures are being monitored, allowing the building of a temperature dependent inphase/quadrature imbalance compensation table. The inphase/quadrature imbalance may be re-estimated when large temperature changes are likely to be detected, allowing the building of a temperature dependent inphase/quadrature imbalance compensation table.

Calculating an estimated inphase/quadrature phase imbalance may include interpolating multiple estimated inphase/quadrature phase imbalances. Calculating an estimated inphase/quadrature amplitude imbalance may also include interpolating multiple estimated inphase/quadrature amplitude imbalances. A local oscillator offset may be selected such that high order product terms and signal mixing with high order products do not interfere with an image or tone. A configurable Rx filter may be used to improve the accuracy of the calculation of the estimated inphase/quadrature phase imbalance.

A wireless device configured for a self-calibrating reduction in inphase/quadrature imbalance is also described. The wireless device includes a processor, memory in electronic communication with the processor and instructions stored in the memory. The instructions are executable by the processor to calculate an inphase/quadrature amplitude imbalance. The instructions are also executable by the processor to apply a correction to the inphase/quadrature amplitude imbalance. The instructions are further executable by the processor to calculate an estimated inphase/quadrature phase imbalance. The instructions executable to calculate an estimated inphase/quadrature phase imbalance include instructions executable to calculate a loopback phase. The instructions are also executable to apply a correction to the inphase/quadrature amplitude imbalance.

A wireless device configured for a self-calibrating reduction in inphase/quadrature imbalance is described. The wireless device includes means for calculating an inphase/quadrature amplitude imbalance. The wireless device also includes means for applying a correction to the inphase/quadrature amplitude imbalance. The wireless device further includes means for calculating an estimated inphase/quadrature phase imbalance. The means for calculating an estimated inphase/quadrature phase imbalance include means for calculating a loopback phase. The wireless device also includes means for applying a correction to the inphase/quadrature amplitude imbalance.

A computer-program product for a self-calibration reduction in inphase/quadrature imbalance is also described. The computer-program product includes a non-transitory computer-readable medium having instructions thereon. The instructions include code for causing a wireless device to calculate an inphase/quadrature amplitude imbalance. The instructions also include code for causing the wireless device to apply a correction to the inphase/quadrature amplitude imbalance. The instructions further include code for causing the wireless device to calculate an inphase/quadrature phase imbalance. Calculating an estimated inphase/quadrature phase imbalance includes calculating a loopback phase. The instructions also include code for causing the wireless device to apply a correction to the inphase/quadrature amplitude imbalance.

### BRIEF DESCRIPTION OF THE DRAWINGS

FIG. 1 shows a wireless communication system with multiple wireless devices;

FIG. 2 is a block diagram illustrating a transceiver in a wireless device;

FIG. 3 is a graph that illustrates improved image leakage due to I/Q imbalance reduction for multiple carriers;

FIG. 4 is a flow diagram of a method for calibrating an FQ imbalance compensation module to reduce I/Q imbalance;

FIG. 5 is a block diagram illustrating a transmitter configured for FQ imbalance estimation and compensation;

FIG. 6 is a flow diagram of a method for calibrating an FQ imbalance module to reduce Tx FQ imbalance;

FIG. 7 is a flow diagram of another method for calibrating an I/Q imbalance module to reduce Tx FQ imbalance;

FIG. 8 is a graph illustrating the result of mixing two local oscillators (LOs) with a Δf offset;

FIG. 9 is a graph illustrating FQ imbalance estimates and estimate interpolation;

FIG. 10 is a block diagram illustrating a receiver configured for FQ imbalance estimation and compensation;

FIG. 11 is a flow diagram of a method for calibrating an I/Q imbalance module to reduce Rx I/Q imbalance;

FIG. 12 is a block diagram illustrating an FQ imbalance compensation circuit;

FIG. 13 illustrates certain components that may be included within a wireless communication device; and

FIG. 14 illustrates certain components that may be included within a base station.

### DETAILED DESCRIPTION

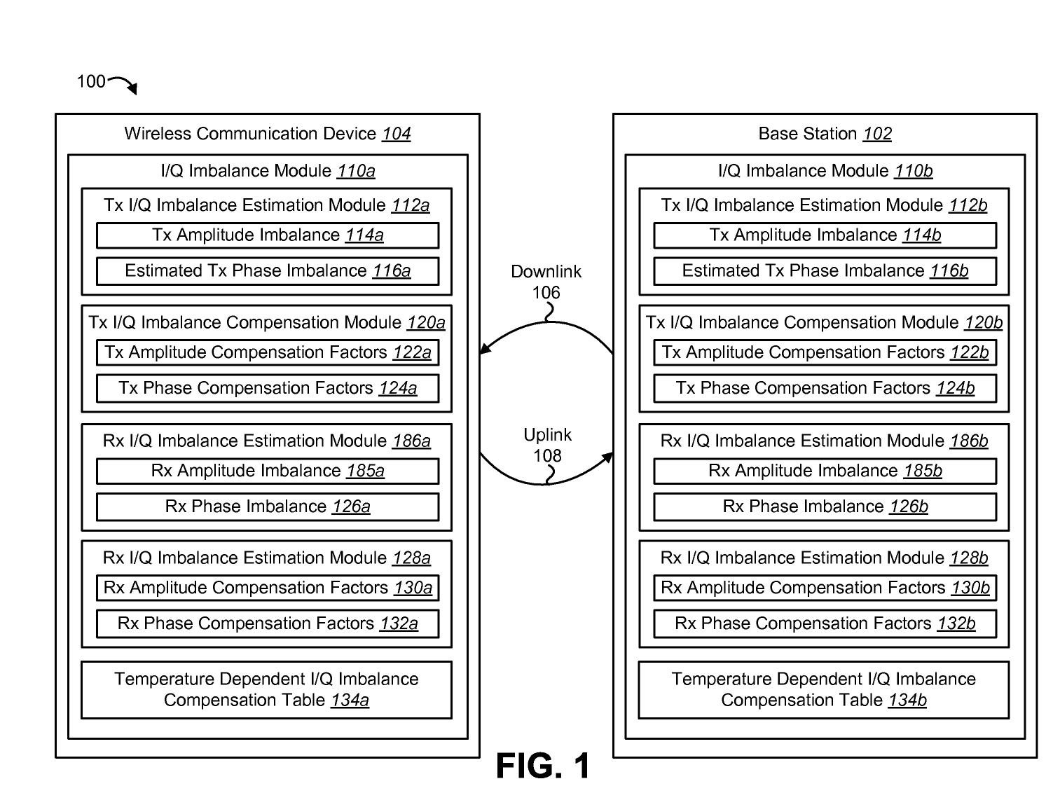

FIG. 1 shows a wireless communication system 100 with multiple wireless devices. Wireless communication systems 100 are widely deployed to provide various types of communication content such as voice, data and so on. A wireless device may be a base station 102 or a wireless communication device 104.

A base station 102 is a station that communicates with one or more wireless communication devices 104. A base station 102 may also be referred to as, and may include some or all of the functionality of, an access point, a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless system (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations 102 on the downlink 106 and/or uplink 108 at any given moment. The downlink 106 (or forward link) refers to the communication link from a base station 102 to a wireless communication device 104, and the uplink 108 (or reverse link) refers to the communication link from a wireless communication device 104 to a base station 102.

A wireless device may include a transmitter and a receiver. The transmitter may condition and upconvert I/Q output baseband signals with transmit local oscillator (LO) signals to obtain an output radio frequency (RF) signal that is more suitable for transmission via a wireless channel. The receiver may receive an input RF signal via the wireless channel. The receiver may downconvert the input RF signal with receive local oscillator (LO) signals to obtain I/Q baseband signals.

The transmitter may include an I branch to condition and upconvert the inphase output baseband signal. The transmitter may also include a Q branch to condition and upconvert the quadrature output baseband signal. Likewise, the receiver may include an I branch to downconvert and condition the received inphase signal and a Q branch to downconvert and condition the received quadrature signal. Ideally, the I branch may be 90 degrees out of phase with respect to the Q branch, with the branches having equal gain. However, an imbalance may exist between the I branch and the Q branch in transmitters and receivers. An imbalance between the gains of the I branch and the Q branch (i.e., when the gains of the branches are not equal) is referred to as an I/Q amplitude imbalance. An imbalance between the phase of the I branch and the Q branch (i.e., when the phase difference between the I branch and the Q branch is different than 90 degrees) may be referred to as an I/Q phase imbalance.

The I/Q imbalances may be a function of direct upconversion/downconversion and imbalances between the I path and the Q path (due to filter mismatches, ADCs, DACs, etc.). To counter I/Q imbalances, a baseband waveform may be digitally frequency rotated. When a baseband waveform is digitally frequency rotated relative to the RF local oscillator (LO), an I/Q imbalance calibration may be necessary to reduce image leakage into the conjugate frequency. A calibration at specific offsets may be required to achieve a high dBc (decibels relative to the carrier). For digitally rotated waveforms, the calibration may be performed at an offset frequency to compensate for mixer and analog baseband amplitude/phase mismatches. For waveforms centered at 0 hertz (Hz), calibration may be performed at an optimal close-in frequency ±f_{offset} and averaged to determine the compensation for the mixer and the analog baseband amplitude/phase mismatches.

Both the base station 102 and the wireless communication device 104 may include an I/Q imbalance module 110a-b. It is desirable that the I/Q imbalance module 110 be fast and have a high accuracy to enable multi-carrier configurations that use a single analog path. The high image rejection requirement necessitates calibration over a wide range of parameters and conditions to account for small variations in amplitude and phase. Factory calibration may be impractical, due to the large number of possible configurations. Thus, self-calibration is more appropriate. Self-calibration frees up factory calibration resources and time needed to calibrate over many parameters. Self-calibration inherently enables recalibration at the user location if necessary. Furthermore, self-calibration requires less memory to store estimates.

An I/Q imbalance module 110 may allow a wireless device to estimate imbalance between an inphase signal and a quadrature signal and then correct this imbalance. An I/Q imbalance module 110 may include a Tx I/Q imbalance estimation module 112a-b for estimating the I/Q imbalance in the transmitter. The Tx I/Q imbalance estimation module 112 may include an estimated Tx amplitude imbalance 114a-b and an estimated Tx phase imbalance 116a-b. In one configuration, the I/Q imbalance module 110 may also include a configurable Rx filter (e.g., a digital bandpass filter) to improve the Tx and/or Rx estimation accuracy by rejecting noise and distortion.

The I/Q imbalance module 110 may also include a Tx I/Q imbalance compensation module 120a-b. The Tx I/Q imbalance compensation module 120a-b may allow the I/Q imbalance module 110 to be self-calibrating (i.e., to compensate for detected Tx amplitude imbalances 114 and Tx phase imbalances 116). The Tx I/Q imbalance compensation module 120 may include Tx amplitude compensation factors 122a-b and Tx phase compensation factors 124a-b.

The I/Q imbalance module 110 may further include an Rx I/Q imbalance estimation module 186a-b for estimating the I/Q imbalance in the receiver. The Rx I/Q imbalance estimation module 186 may include an estimated Rx amplitude imbalance 185a-b and an estimated Rx phase imbalance 126a-b. The I/Q imbalance module 110 may also include an Rx I/Q imbalance compensation module 128a-b. The Rx I/Q imbalance compensation module 128 may allow the I/Q imbalance module 110 to be self-calibrating. The Rx I/Q imbalance compensation module 128 may include Rx amplitude compensation factors 130a-b and Rx phase compensation factors 132a-b.

Tx I/Q imbalance estimation may be applied on multiple blocks of data and the results may be averaged to increase the accuracy of the estimate. Rx I/Q imbalance estimation may use multiple concatenated blocks of data that do not need to be phase aligned. Each block of data must have an integer multiple of cycles of the calibration tone frequency. An artificial Tx I/Q phase imbalance (e.g., 5 degrees) may be introduced to aid in estimating the Tx phase imbalance 116. The artificial Tx I/Q phase imbalance may then be removed from the estimate before the phase compensation factors 124 are calculated. The Rx I/Q imbalance estimation may utilize induced Tx local oscillator (LO) leakage (single tone) and Tx/Rx local oscillator (LO) offset as the calibration offset. For each set of captured data, any DC component must be removed, as this may skew the estimates. The Rx I/Q imbalance may be performed simultaneously with the Tx phase imbalance estimation by setting the Rx frequency rotator to 0 Hz if the resulting Rx local oscillator (LO) and tone offset at the Rx digital front end (DFE) are the desired calibration parameters. The Rx calibration does not require separate captures for amplitude estimation and loopback phase computation.

Narrowband (single tap) Tx and Rx I/Q imbalance estimation/correction may be used to achieve >50 dBc post-correction image rejection. The I/Q imbalance estimation may be performed at arbitrary offsets from the transmitter local oscillator (LO) and the receiver local oscillator (LO). In one configuration, the I/Q imbalance estimation may be performed using a Tx-Rx RF loopback (so that no external equipment is required). The I/Q imbalance module may not require a calibration of the Rx I/Q imbalance prior to performing the Tx I/Q imbalance estimation.

For Tx I/Q imbalance estimation, the loopback (i.e., the phase component of the loopback channel) and Tx/Rx local oscillator phase may be determined. The loopback phase (i.e., the loopback and the Tx/Rx local oscillator phase considered collectively) may have the effect of distorting Tx I/Q imbalance estimations.

In high image rejection calibrated I/Q imbalance scenarios, temperature variations can change the image ratio. To maintain high image rejection, the temperature may be monitored and appropriate changes may be made to the I/Q imbalance compensation according to changes in the temperature. In one configuration, the I/Q imbalance may be estimated during warm-up while temperatures are being monitored and/or re-estimated (using self-calibration) when large temperature changes are likely to be detected, allowing the I/Q imbalance module 110 to build a temperature dependent I/Q imbalance compensation table 134a-b.

One advantage of the I/Q imbalance module 110 of the present systems and methods is that no external equipment is required (since the I/Q imbalance module 110 can perform self-calibration). Factory calibration may be impractical, due to the large number of LO/carrier offset combinations. Additionally, no time-consuming mathematical operations (e.g., a fast Fourier Transform (FFT)) are required. The I/Q imbalance module 110 may provide a decoupled estimation of the Tx I/Q imbalances and the Rx I/Q imbalances using a close-form (non-iterative) estimation.

The I/Q imbalance estimation algorithm may utilize an RF loopback path from Tx to Rx. Tones may be generated using a frequency rotator in the Tx digital front-end (DFE) at the calibration frequency offset for Tx I/Q imbalance estimation. A large local oscillator (LO) leakage may be generated using DC from the Tx digital front-end (DFE) for Rx I/Q imbalance estimation. Band-pass filtering may be employed in the Rx digital front-end (DFE) to clean up captured tones. Time-domain tones may be captured in the Rx digital front-end (DFE) memory after loopback (multiple captures may be used to improve the estimation process). The Tx/Rx local oscillator (LO) offset may be removed in the Rx digital front-end (DFE) using a frequency rotator for Tx I/Q imbalance estimation. For the Tx I/Q imbalance estimation, the Tx amplitude imbalance 114 may initially be estimated using Tx real tones (inphase-only, quadrature-only) before compensation is applied. The estimated Tx phase imbalance 116 may then be estimated using a Tx complex tone. The loopback phase may be calculated and applied to correctly estimate the Tx phase imbalance 116.

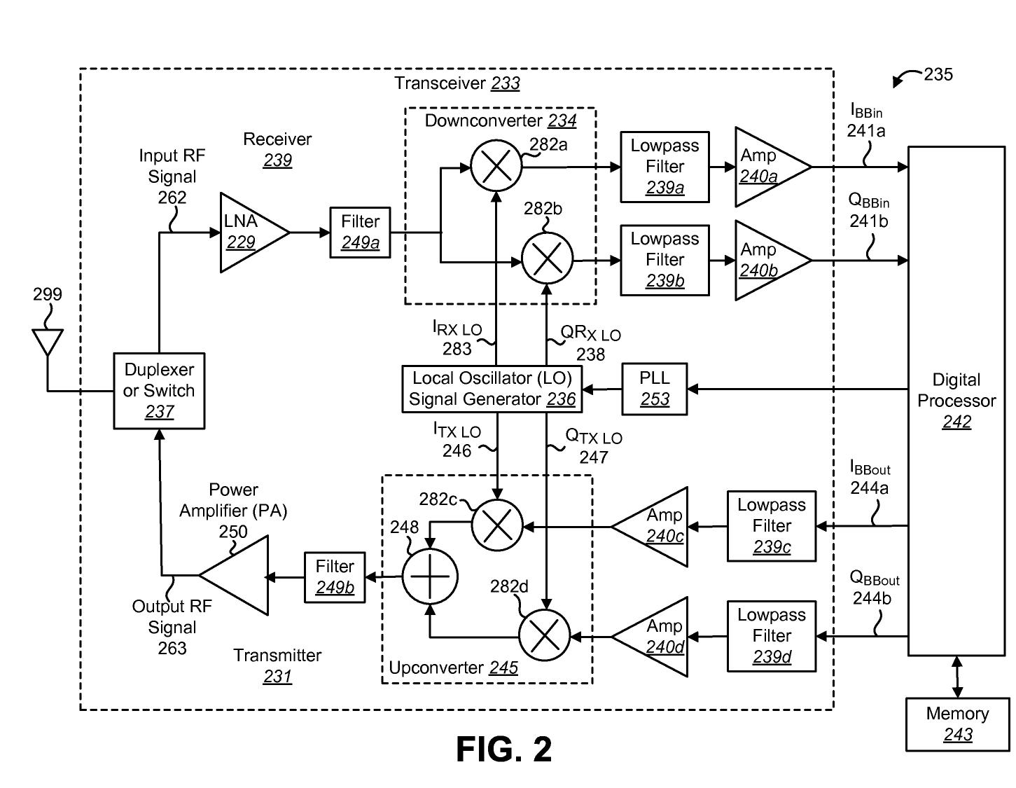

FIG. 2 is a block diagram illustrating a transceiver 233 in a wireless device 235. The wireless device 235 may be a base station 102 or a wireless communication device 104. The wireless device 235 may include the transceiver 233, a digital processor 242 and memory 243. The transceiver 233 may include a receiver 239 and a transmitter 231 that support bi-directional communication. In general, the wireless device 235 may include any number of receivers 239 and any number of transmitters 231 for any number of communication systems and any number of frequency bands.

A receiver 239 or a transmitter 231 may be implemented with a super-heterodyne architecture or a direct-conversion architecture. In the super-heterodyne architecture, a signal is frequency converted between RF and baseband in multiple stages, e.g., from RF to an intermediate frequency (IF) in one stage, and then from IF to baseband in another stage for a receiver 239. In the direct-conversion architecture, a signal is frequency converted between RF and baseband in one stage. The super-heterodyne and direct-conversion architectures may use different circuit blocks and/or have different requirements. In the wireless device 235 shown, the receiver 239 and the transmitter 231 are implemented using the direct-conversion architecture.

In the Rx path (i.e., the receiver 239), an antenna 299 receives wireless signals. The wireless signals are provided to a duplexer or switch 237 that then provides an input RF signal 262 to the receiver 239. Within the receiver 239, the input RF signal 262 is amplified by a low noise amplifier (LNA) 229 and filtered by a filter 249a to obtain a filtered RF signal. A downconverter 234 receives the filtered RF signal. The downconverter 234 also receives an inphase receive (Rx) local oscillator (LO) signal I_{Rx}_{_{—}}_{LO} 283 and a quadrature receive (Rx) local oscillator (LO) signal Q_{Rx}_{_{—}}_{LO} 238 from a local oscillator (LO) signal generator 236. Within the downconverter 234, a mixer 282a may downconvert the filtered RF signal with the inphase receive (Rx) local oscillator (LO) signal I_{Rx}_{_{—}}_{LO} 283. A mixer 282b may downconvert the filtered RF signal with the quadrature receive (Rx) local oscillator (LO) signal Q_{Rx}_{_{—}}_{LO} 238. The inphase downconverted signal may be passed through a lowpass filter 239a to remove undesired images, undesired signals, out-of-band noise, interference, etc. Likewise, the quadrature downconverted signal may be passed through a lowpass filter 239b to remove undesired images, undesired signals, out-of-band noise, interference, etc. The inphase filtered signal and the quadrature filtered signal may each be amplified by an amplifier 240a-b to obtain the desired signal amplitude. The baseband inphase receive signal I_{BBin} 241a and the baseband quadrature receive signal Q_{BBin} 241b may then be provided to the digital processor 242.

In the Tx path (i.e., the transmitter 231), the digital processor 242 may process data to be transmitted and provide an inphase transmit baseband signal I_{BBout} 244a and a quadrature transmit baseband signal Q_{BBout} 244b to the transmitter 231. Within the transmitter 231, a lowpass filter 239c may filter inphase transmit baseband signal I_{BBout} 244a to remove undesired images caused by the prior digital-to-analog conversion. The output of the lowpass filter 239c may be amplified using an amplifier 240c. A lowpass filter 239d may filter the quadrature transmit baseband signal Q_{BBout} 244b to remove undesired images caused by the prior digital-to-analog conversion. The output of the lowpass filter 239d may be amplified using an amplifier 240d.

An upconverter 245 may receive the amplified inphase and quadrature signals from the amplifiers 240c-d. The upconverter 245 may also receive an inphase transmit (Tx) local oscillator (LO) signal I_{Tx}_{_{—}}_{LO} 246 and a quadrature transmit (Tx) local oscillator (LO) signal Q_{Tx}_{_{—}}_{LO} 247 from the local oscillator (LO) signal generator 236. The upconverter 245 may include a mixer 282c that upconverts the inphase amplified signal with the inphase transmit (Tx) local oscillator (LO) signal I_{Tx}_{_{—}}_{LO} 246, a mixer 282d that upconverts the quadrature transmit (Tx) local oscillator (LO) signal Q_{Tx}_{_{—}}_{LO} 247 and a summer 248 that sums the outputs of the mixers 282c-d to obtain an upconverted signal. The upconverted signal may be provided to a filter 249b to remove images caused by the frequency upconversion as well as noise in a receive frequency band. The output of the filter 249b may be provided to a power amplifier (PA) 250 that amplifies the signal to obtain the desired output power level for the output RF signal 263. The output RF signal 263 may be routed through the duplexer or switch 237 and transmitted via the antenna 299.

The local oscillator (LO) signal generator 236 may generate the inphase receive (Rx) local oscillator (LO) signal I_{Rx}_{_{—}}_{LO} 283 and the quadrature receive (Rx) local oscillator (LO) signal I_{Rx}_{_{—}}_{LO} 238 used by the receiver 239 for frequency downconversion. The local oscillator (LO) signal generator 236 may also generate the inphase transmit (Tx) local oscillator (LO) signal I_{Tx}_{_{—}}_{LO} 246 and the quadrature transmit (Tx) local oscillator (LO) signal Q_{Tx}_{_{—}}_{LO} 247 used by the transmitter 231 for frequency upconversion. A phase locked loop (PLL) 253 may receive timing information from the digital processor 242 and generate control signals used to adjust the frequency and/or phase of the Rx local oscillator (LO) signals and the Tx local oscillator (LO) signals provided by the local oscillator (LO) signal generator 236.

FIG. 2 provides one example of a transceiver 233. In general, the conditioning of the signals in a transmitter 231 and a receiver 239 may be performed by one or more stages of amplifier, filter, upconverter 245, downconverter 234, etc. These circuit blocks may be arranged differently from the configuration shown in FIG. 2. Furthermore, other circuit blocks not shown in FIG. 2 may also be used to condition the signals in the transmitter 231 and receiver 239. Some circuit blocks may also be omitted. All or a portion of the transceiver 233 may be implemented on one or more analog integrated circuits (ICs), RF ICs (RFICs), mixed-signal ICs, etc.

The digital processor 242 may include various processing units for data transmission and reception and other functions. For example, the digital processor 242 may include a digital signal processor (DSP), a reduced instruction set computer (RISC) processor, a central processing unit (CPU), etc. The memory 243 may store program codes and data for the wireless device 235. The digital processor 242 and/or the memory 243 may be implemented on one or more application specific integrated circuits (ASICs) and/or other ICs.

The receiver 239 and the transmitter 231 may have I/Q imbalances, which may result from circuit blocks in the I branch not matching circuit blocks in the Q branch. For example, I/Q imbalances may occur due to gain imbalance between the I and Q branches and a phase error between the I and Q branches. I/Q imbalances may also occur due to different frequency responses for the I and Q branches. In any case, I/Q imbalances may degrade the performance of receiver 239 and a transmitter 231.

I/Q imbalances in the receiver 239 and the transmitter 231 may be estimated and compensated in order to improve the performance of the receiver 239 and transmitter 231. The I/Q imbalances may be estimated at different frequencies (i.e., different local oscillator (LO) frequencies and different baseband frequency offsets) to obtain frequency-dependent gain imbalances and phase errors between the I and Q branches of the receiver 239 and transmitter 231. The I/Q imbalances may then be compensated for across the frequency spectrum, which may provide better performance than compensation at a single frequency.

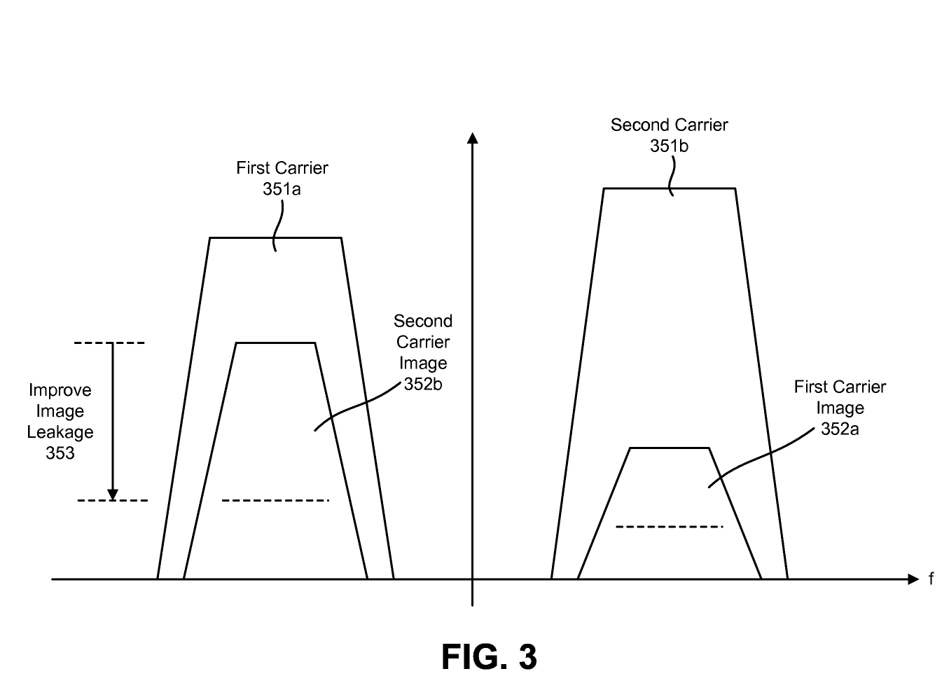

FIG. 3 is a graph that illustrates improved image leakage 353 due to I/Q imbalance reduction for multiple carriers. A first carrier 351a and a second carrier 351b are illustrated. The first carrier 351a and the second carrier 351b are separated in frequency. Due to an I/Q imbalance, an image 352a from the first carrier 351a may appear on the second carrier 351b and an image 352b from the second carrier 351b may appear on the first carrier 351a. Reducing the I/Q imbalance may result in image suppression for multi-carrier applications using a single analog path and digital rotators (e.g., 1x/DO concurrency). Reducing the I/Q imbalance may also result in increased error vector magnitude (EVM) for high order constellation waveforms (e.g., for LTE).

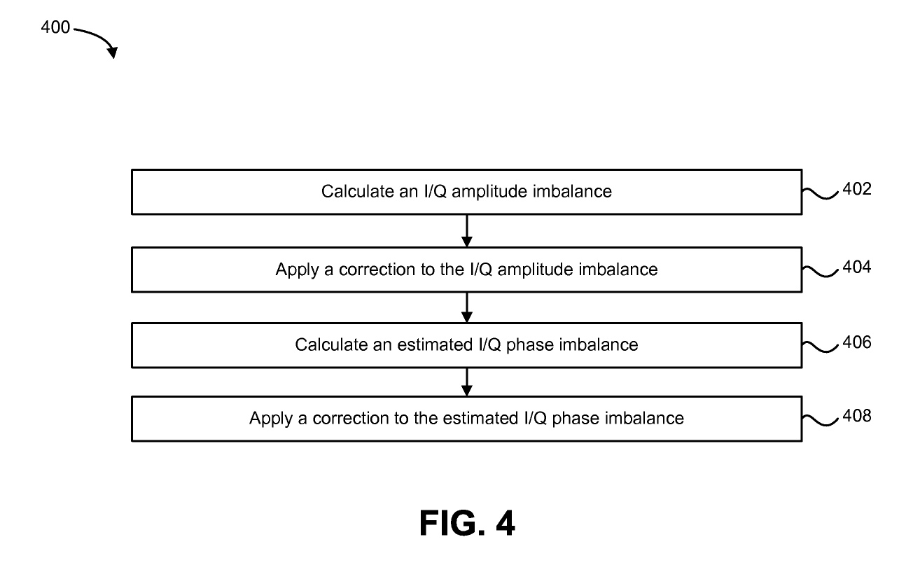

FIG. 4 is a flow diagram of a method 400 for calibrating an I/Q imbalance compensation module 120 to reduce I/Q imbalance. The method 400 may be performed by a wireless device 235 such as a base station 102 or a wireless communication device 104. The method 400 may be performed for Tx I/Q imbalance or Rx I/Q imbalance. The wireless device 235 may calculate 402 an I/Q amplitude imbalance. The wireless device 235 may then apply 404 a correction to the I/Q amplitude imbalance. The wireless device 235 may also calculate 406 an estimated I/Q phase imbalance. The wireless device 235 may then apply 408 a correction to the estimated I/Q phase imbalance.

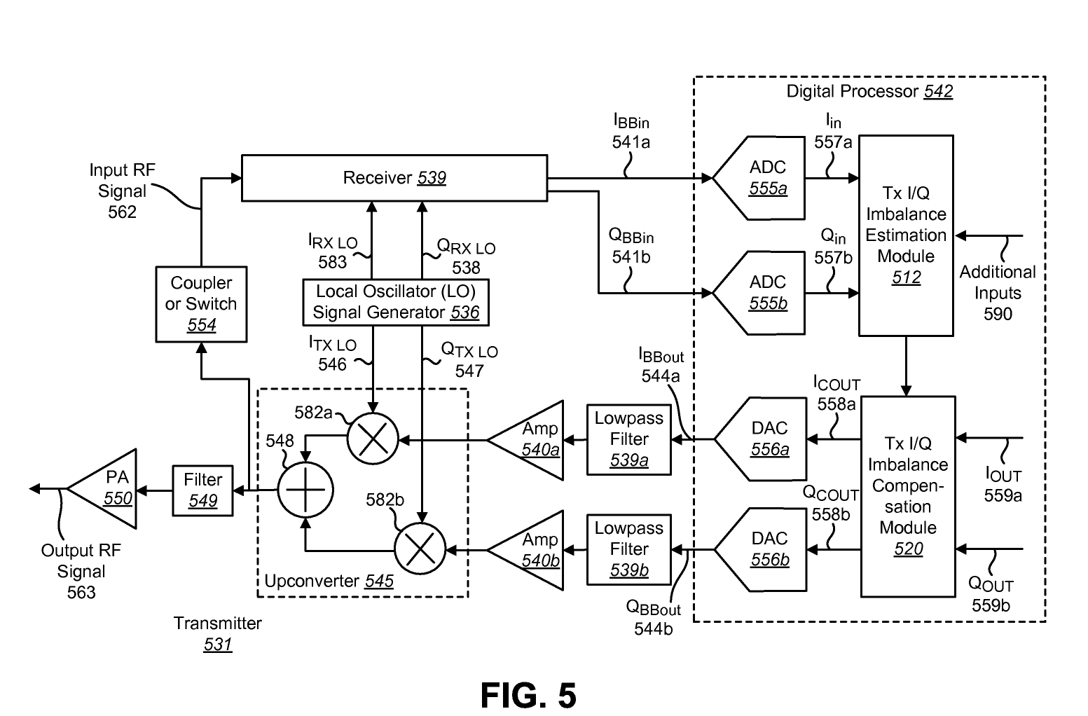

FIG. 5 is a block diagram illustrating a transmitter 531 configured for I/Q imbalance estimation and compensation. The transmitter 531 may be part of a transceiver 233 on a wireless device 235. The transceiver 233 may include a digital processor 542. Within the digital processor 542, a Tx I/Q imbalance compensation module 520 may receive and process I and Q output samples Tout 559a and Qout 559b to compensate for I/Q imbalances between the I and Q branches of the transmitter 531. The Tx I/Q imbalance compensation module 520 may provide I compensated output samples Icout 558a to a first digital-to-analog converter (DAC) 556a and Q compensated output samples Qcout 558b to a second digital-to-analog converter (DAC) 556b. The first digital-to-analog converter (DAC) 556a may output an I baseband signal IBBout 544a. The second digital-to-analog converter (DAC) 556b may output a Q baseband signal QBBout 544b. The transmitter 531 may process the I and Q output baseband signals IBBout 544a and QBBout 544b and provide an output RF signal 563.

The I baseband signal IBBout 544a may be passed through a lowpass filter 539a and an amplifier 540a before being mixed using a mixer 582a in an upconverter 545 on the transmitter 531. The mixer 582a may receive an I Tx local oscillator (LO) signal ITx_LO 546 from a local oscillator (LO) signal generator 536. The Q baseband signal QBBout 544b may be passed through a lowpass filter 539b and an amplifier 540b before being mixed using a mixer 582b in the upconverter 545 on the transmitter 531. The mixer 582b may receive a Q Tx local oscillator (LO) signal QTx_LO 547 from the local oscillator (LO) signal generator 536.

The outputs from the mixers 582 may then be combined using an adder 548. The combined signal may pass through a coupler or switch 554 that feeds back the signal (as an input RF signal 562) through the receiver 539. The combined signal may also be passed through a filter 549 and a power amplifier (PA) 550 to obtain the output RF signal 563.

The coupler or switch 554 may be between the upconverter 545 and the filter 549. In one configuration, the coupler or switch 554 may be between the filter 549 and the power amplifier (PA) 550 or coupled to the output of the power amplifier (PA) 550. The coupler or switch 554 may provide a portion of the upconverted signal from the upconverter 545 as the input RF signal 562 to the receiver 539. The receiver 539 may process the input RF signal 562 (using an inphase receive (Rx) local oscillator (LO) signal I_{Rx}_{_{—}}_{LO} 583 and a quadrature receive (Rx) local oscillator (LO) signal Q_{Rx}_{_{—}}_{LO} 538) and provide a baseband inphase receive signal I_{BBin} 541a to an analog-to-digital converter (ADC) 555a in the digital processor 542 and a baseband quadrature receive signal Q_{BBin} 541b to an analog-to-digital converter (ADC) 555b in the digital processor 542.

In the inphase path, the analog-to-digital converter (ADC) 555a may output an inphase input signal Iᵢₙ 557a to the Tx I/Q imbalance estimation module 512. The Tx I/Q imbalance estimation module 512 may receive additional inputs 590, such as a local oscillator (LO) offset, a calibration frequency, etc. In the quadrature path, the analog-to-digital converter (ADC) 555b may output a quadrature input signal Qᵢₙ 557b to the Tx I/Q imbalance estimation module 512. The Tx I/Q imbalance estimation module 512 may estimate the I/Q imbalances between the inphase and quadrature branches of the transmitter 531 and provide a frequency response of the amplitude and phase imbalances between the inphase and quadrature branches of the transmitter 531 to the Tx I/Q imbalance compensation module 520. The Tx I/Q imbalance compensation module 520 may determine and apply amplitude compensation factors 122 and phase compensation factors 124 to compensate for I/Q imbalances in the transmitter 531.

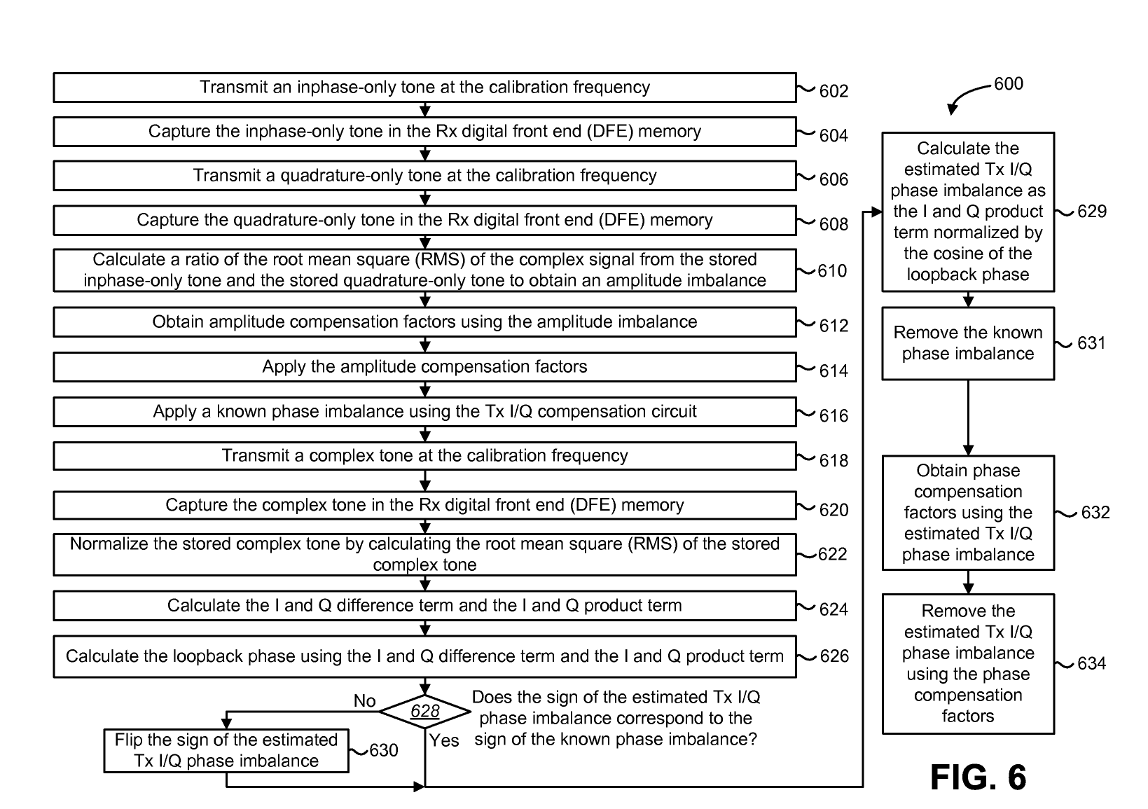

FIG. 6 is a flow diagram of a method 600 for calibrating an I/Q imbalance module 110 to reduce Tx I/Q imbalance. The method 600 may be performed by a wireless device 235 such as a base station 102 or a wireless communication device 104. The wireless device 235 may transmit 602 an inphase-only tone at the calibration frequency. The wireless device 235 may then capture 604 the inphase-only tone in the Rx digital front-end (DFE) memory. The wireless device 235 may also transmit 606 a quadrature-only tone at the calibration frequency. The wireless device 235 may then capture 608 the quadrature-only tone in the Rx digital front-end (DFE) memory.

The wireless device 235 may calculate 610 a ratio of the root mean square (RMS) of the complex signal from the stored inphase-only tone and the stored quadrature-only tone to obtain an amplitude imbalance. The amplitude imbalance 114 may be found using Equation (1):

$${α}_{Tx} = \sqrt{\frac{{\int }_{0}^{T} {\vert {y}_{x\_I} ( t ) \vert}^{2} d t}{{\int }_{0}^{T} {\vert {y}_{x\_Q} ( t ) \vert}^{2} d t}} . \qquad ( 1 )$$

The Equations herein are written in continuous time, but it is implied that processing is done on discrete samples. In Equation (1), yₓ_{_{—}}_{I}(t) is the received signal when only the Tx inphase branch is active (i.e., the received signal when an inphase-only tone was transmitted) and yₓ_{_{—}}_{Q}(t) is the received signal when only the Tx quadrature branch is active (i.e., the received signal when a quadrature-only tone was transmitted). α_{Tx} is the Tx I/Q amplitude imbalance 114. The root mean square (RMS) may be calculated on the complex Rx waveform when only the Tx inphase or quadrature branch is active. The loopback phase means that the real signal transmitted will be complex when received. The loopback phase (as viewed from the Rx baseband after loopback) may result in a rotation of the complex tone. An I/Q imbalance may cause the ideal unit circle complex tone to be distorted. Furthermore, a loopback phase rotation of the distorted complex tone may result in a blurring of the distinction between amplitude and phase imbalances. If the I/Q imbalance is phase only, the loopback phase may cause amplitude imbalances to be estimated (and vice-versa). Therefore, the loopback phase must be addressed in order to correctly estimate Tx I/Q imbalances.

The wireless device 235 may then obtain 612 amplitude compensation factors 122 using the amplitude imbalance 114. The amplitude compensation factors 122 may be obtained differently for each compensation circuit. For example, in one configuration, the amplitude compensation factors 122 may be obtained by scaling by the amplitude ratio: if (Irms>Qrms), I′=I/alpha; else Q′=Q*alpha, where alpha=Irms/Qrms is the amplitude imbalance estimate. The wireless device 235 may apply 614 the amplitude compensation factors 122 in the Tx I/Q imbalance compensation module 120 to reduce the Tx I/Q amplitude imbalance 114.

The wireless device 235 may apply 616 a known phase imbalance using the Tx I/Q compensation circuit. The known phase imbalance may be greater than the possible actual I/Q phase imbalance. The wireless device 235 may then transmit 618 a complex tone at the calibration frequency. The wireless device 235 may capture 620 the complex tone in the Rx digital front-end (DFE) memory. The wireless device 235 may normalize 622 the stored complex tone by calculating the root mean square (RMS) of the stored complex tone. The wireless device 235 may calculate 624 the I and Q difference term and the I and Q product term. The I and Q difference term is ŷ̅_̅{̅I̅}̅²̅(̅t̅)̅− ŷ̅_̅{̅Q̅}̅²̅(̅t̅)̅, where ŷ̅_̅{̅I̅}̅²̅(̅t̅)̅ is the mean of the square of the normalized received inphase baseband signal and y (t) is the mean of the square of the normalized received quadrature baseband signal. The I and Q product term is ŷ̅_̅{̅I̅}̅(̅t̅)̅ŷ̅_̅{̅Q̅}̅(̅t̅)̅ ŷ̅_̅{̅I̅}̅(̅t̅)̅ŷ̅_̅{̅Q̅}̅(̅t̅)̅. The wireless device 235 may then calculate 626 the loopback phase using the I and Q difference term and the I and Q product term in Equation (2):

$$\begin{matrix}{\hat{ϕ}}_{n} = \frac{1}{2} {tan}^{- 1} ( - \frac{\overline{{\hat{y}}_{I}^{2} ( t )} - \overline{{\hat{y}}_{Q}^{2} ( t )}}{2 ( \overline{{\hat{y}}_{I} ( t ) {\hat{y}}_{Q} ( t )} )} ) \\ = \frac{1}{2} {tan}^{- 1} ( - \frac{sin ( 2 {ϕ}_{n} ) sin ( {φ}_{Tx} )}{sin ( {φ}_{Tx} ) cos ( 2 {ϕ}_{n} )} ) \\ = \frac{1}{2} {tan}^{- 1} ( tan ( 2 {ϕ}_{n} ) )\end{matrix} . \qquad ( 2 )$$

In one configuration, the arctangent may be a 4 quadrant (a tan 2( )), which removes the need to check for the sign. In Equation (2), \hat{φ}ₙ is the loopback phase estimate for the given capture n and φ_{Tx} is the estimated Tx I/Q phase imbalance 116. Equation (2) uses a closed form calculation of the loopback phase. The resulting loopback phase estimate \hat{φ}ₙ is constrained to

$$- \frac{π}{4} … \frac{π}{4} .$$

In Equation (2), ŷ̅_̅{̅I̅}̅²̅(̅t̅)̅ is the averaged square of the inphase signal. ŷ̅_̅{̅I̅}̅²̅(̅t̅)̅ may be found using Equation (3):

$$\begin{matrix}\overline{{\hat{y}}_{I}^{2} ( t )} = \frac{1}{T} {\int }_{0}^{T} \{ \begin{matrix}{cos}^{2} ( {ω}_{t} t ) {cos}^{2} ( {ϕ}_{n} - \frac{φ}{2} ) - \\ 2 cos ( {ω}_{t} t ) sin ( {ω}_{t} t ) cos ( {ϕ}_{n} - \frac{φ}{2} ) \\ sin ( {ϕ}_{n} + \frac{φ}{2} ) + {sin}^{2} ( {ω}_{t} t ) {sin}^{2} ( {ϕ}_{n} + \frac{φ}{2} )\end{matrix} \} d t \\ = \frac{1}{2} [ {cos}^{2} ( {ϕ}_{n} - \frac{φ}{2} ) + {sin}^{2} ( {φ}_{n} + \frac{φ}{2} ) ] \\ = \frac{1}{4} [ 2 + cos ( 2 {ϕ}_{n} - φ ) - cos ( 2 {ϕ}_{n} + φ ) ]\end{matrix} . \qquad ( 3 )$$

A similar analysis yields the averaged square of the quadrature signal ŷ̅_̅{̅Q̅}̅²̅(̅t̅)̅ in Equation (4):

ŷ̅_̅{̅Q̅}̅²̅(̅t̅)̅=¼[2+cos(2φₙ+φ)−cos(2φₙ−φ)]. (4)

In Equation (3) and Equation (4), ŷ_{I}(0 is the normalized received inphase baseband signal, ŷ_{Q}(t) is the normalized received quadrature baseband signal, ωₜ is the calibration tone frequency, φₙ is the loopback phase for the given capture and φ is the estimated Tx I/Q phase imbalance 116. The I and Q signals may be normalized by a complex signal root mean square (RMS). In Equation (2), the I and Q difference term ŷ̅_̅{̅I̅}̅²̅(̅t̅)̅− ŷ̅_̅{̅Q̅}̅²̅(̅t̅)̅ may be found using Equation (5):

$$\begin{matrix}\overline{{\hat{y}}_{I}^{2} ( t )} - \overline{{\hat{y}}_{Q}^{2} ( t )} = \frac{1}{2} [ cos ( 2 {ϕ}_{n} - φ ) - cos ( 2 {ϕ}_{n} + φ ) ] \\ = sin ( 2 {ϕ}_{n} ) sin ( φ )\end{matrix} . \qquad ( 5 )$$

The estimated Tx I/Q phase imbalance φ_{Tx} 116 of Equation (2) may be calculated using Equation (6):

$${φ}_{Tx} = {sin}^{- 1} ( - \frac{2 ( \overline{{\hat{y}}_{I} ( t ) {\hat{y}}_{Q} ( t )} )}{cos ( 2 {\hat{ϕ}}_{n} )} ) . \qquad ( 6 )$$

In Equation (6), ŷ̅_̅{̅I̅}̅(̅t̅)̅ŷ̅_̅{̅Q̅}̅(̅t̅)̅ ŷ̅_̅{̅I̅}̅(̅t̅)̅ŷ̅_̅{̅Q̅}̅(̅t̅)̅ is the averaged product of the normalized I and Q signals. The averaged product of the normalized I and Q signals may be found using Equation (7):

$$\begin{matrix}\overline{{\hat{y}}_{I} ( t ) {\hat{y}}_{Q} ( t )} = \frac{1}{T} {\int }_{0}^{T} \{ \begin{matrix}{cos}^{2} ( {ω}_{t} t ) cos ( {ϕ}_{n} - \frac{φ}{2} ) sin ( {ϕ}_{n} - \frac{φ}{2} ) + \\ cos ( {ω}_{t} t ) sin ( {ω}_{t} t ) cos ( {ϕ}_{n} - \frac{φ}{2} ) cos \\ ( {ϕ}_{n} + \frac{φ}{2} ) - sin ( {ω}_{t} t ) cos ( {ω}_{t} t ) sin \\ ( {ϕ}_{n} + \frac{φ}{2} ) sin ( {ϕ}_{n} - \frac{φ}{2} ) - {sin}^{2} ( {ω}_{t} t ) sin \\ ( {ϕ}_{n} + \frac{φ}{2} ) cos ( {ϕ}_{n} + \frac{φ}{2} )\end{matrix} \} d t \\ = \frac{1}{4} [ sin ( 2 {ϕ}_{n} - φ ) - sin ( 2 {ϕ}_{n} + φ ) ] \\ = - \frac{1}{2} sin ( φ ) cos ( 2 {ϕ}_{n} )\end{matrix} . \qquad ( 7 )$$

Equation (7) is averaged over N cycles of the calibration tone frequency. The wireless device 235 may then determine 628 whether the sign of the estimated Tx I/Q phase imbalance φ_{Tx} 116 corresponds to the sign of the applied known phase imbalance. If the Tx I/Q phase estimate sign does not correspond to the applied known phase imbalance, the wireless device 235 may flip 630 the sign of the estimated Tx I/Q phase imbalance 116 and then calculate 629 the estimated Tx I/Q phase imbalance 116. If the Tx I/Q phase estimate sign does correspond to the applied known phase imbalance, the wireless device 235 may calculate 629 the estimated Tx I/Q phase imbalance 116 as the I and Q product term normalized by the cosine of the loopback phase (see Equation (6) above). The wireless device may then obtain 632 phase compensation factors 124 using the estimated Tx I/Q phase imbalance 116. The wireless device 235 may remove 634 the estimated Tx I/Q phase imbalance 116 using the phase compensation factors 124. In other words, the wireless device 235 may apply the phase compensation factors 124 to signals in the transmitter 231 to remove 634 the estimated Tx I/Q phase imbalance 116. A pseudo code for removing 634 the estimated Tx I/Q phase imbalance 116 using the phase compensation factors 124 for a given configuration of a compensation circuit is given below:

//assume that the phase imbalance is in the linear region of tan( ) -->
valid for
//small I/Q phase imbalance, which is typically the case
if(amp_imbalance>1.0)
{

if(phase_imbalance>=0.0)
{

iCGain =(1.0/amp_imbalance)*(phase_imbalance/2.0);
qCGain =1.0*(phase_imbalance/2.0);

}
else
{

iCGain =(1.0/amp_imbalance)*(phase_imbalance/2.0);
qCGain =1.0*(phase_imbalance/2.0);

}

}
else
{

if(phase_imbalance>=0.0)
{

iCGain =1.0*(phase_imbalance/2.0);
qCGain =(1.0*amp_imbalance)*(phase_imbalance/2.0);

}
else
{

iCGain =1.0*(phase_imbalance/2.0);
qCGain =(1.0*amp_imbalance)*(phase_imbalance/2.0);

}

}

The received baseband inphase signal y_{I}(t) with Tx I/Q amplitude imbalance corrected may be expressed using Equation (8):

$$\begin{matrix}{y}_{I} ( t ) = LPF \{ cos ( {ω}_{c} t + {ϕ}_{n} ) [ cos ( {ω}_{t} t ) cos ( {ω}_{c} t + \frac{φ}{2} ) + \\ sin ( {ω}_{t} t ) sin ( {ω}_{c} t - \frac{φ}{2} ) ] \} \\ = \frac{1}{2} [ cos ( {ω}_{t} t ) cos ( {φ}_{n} - \frac{φ}{2} ) - sin ( {ω}_{t} t ) sin ( {φ}_{n} + \frac{φ}{2} ) ]\end{matrix} . \qquad ( 8 )$$

The received baseband quadrature signal y_{Q}(t) with Tx amplitude imbalance corrected may be expressed using Equation (9):

$$\begin{matrix}{y}_{Q} ( t ) = LPF \{ sin ( {ω}_{c} t + {ϕ}_{n} ) [ cos ( {ω}_{t} t ) cos ( {ω}_{c} t + \frac{φ}{2} ) + \\ sin ( {ω}_{t} t ) sin ( {ω}_{c} t - \frac{φ}{2} ) ] \} \\ = \frac{1}{2} [ cos ( {ω}_{t} t ) sin ( {ϕ}_{n} - \frac{φ}{2} ) + sin ( {ω}_{t} t ) cos ( {ϕ}_{n} + \frac{φ}{2} ) ]\end{matrix} . \qquad ( 9 )$$

In Equation (8) and Equation (9), ωₜ is the calibration tone frequency, ω_{c} is the RF carrier frequency, φₙ is the loopback phase for the given capture and φ is the Tx I/Q phase imbalance 116. Although the local oscillators (LOs) used for receiving and transmitting are different, since a numerically controlled oscillator (NCO) is used to effectively make the carrier identical, Equation (8) and Equation (9) are simplified to reflect that the Tx and Rx local oscillators (LOs) are identical. As a result of the local oscillator (LO) offset, the Rx I/Q imbalance is not a concern. The ½ in Equation (8) and Equation (9) may be ignored in subsequent calculations, as normalization is required.

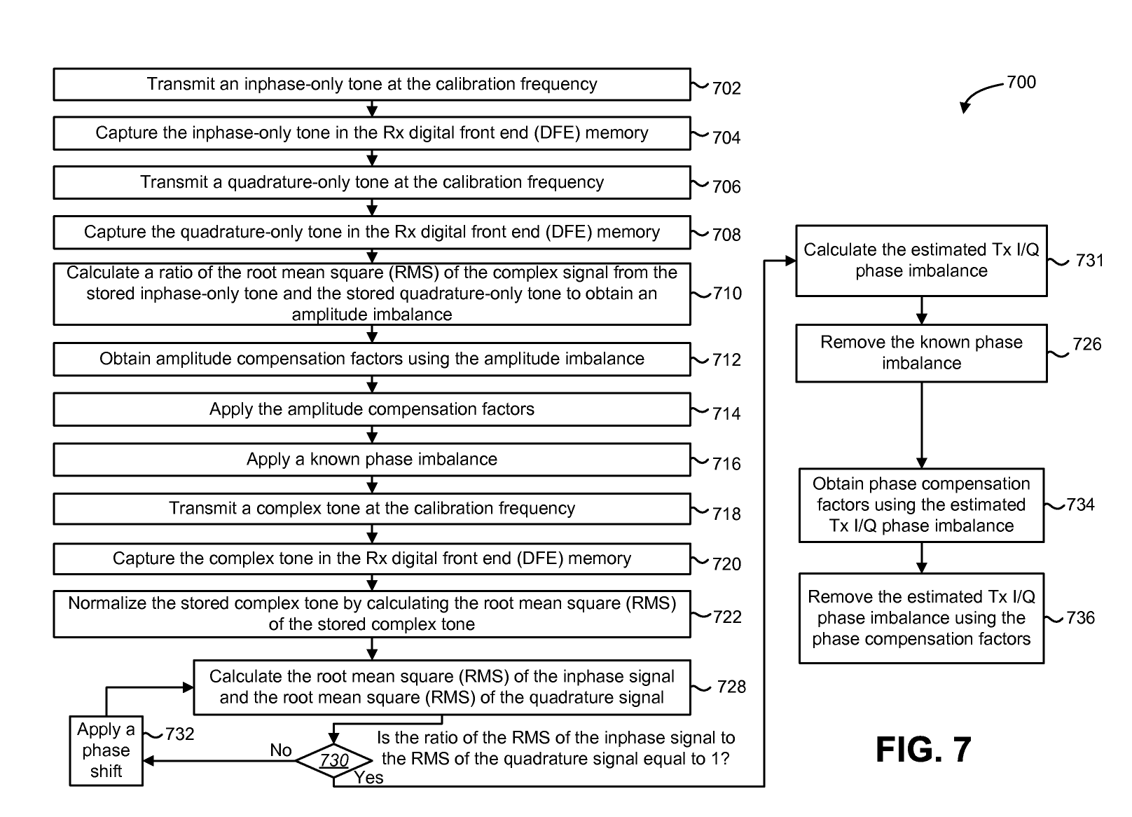

FIG. 7 is a flow diagram of another method 700 for calibrating an I/Q imbalance module to reduce Tx I/Q imbalance. The method 700 uses a brute-force determination of the loopback phase by comparing the root mean square (RMS) of signals in the inphase and quadrature branches. The method 700 may be performed by a wireless device 235 such as a base station 102 or a wireless communication device 104. The wireless device 235 may transmit 702 an inphase-only tone at the calibration frequency. The wireless device 235 may then capture 704 the inphase-only tone in the Rx digital front-end (DFE) memory. The wireless device 235 may also transmit 706 a quadrature-only tone at the calibration frequency. The wireless device 235 may then capture 708 the quadrature-only tone in the Rx digital front-end (DFE) memory.

The wireless device 235 may calculate 710 a ratio of the root mean square (RMS) of the complex signal from the stored inphase-only tone and the stored quadrature-only tone to obtain an amplitude imbalance using Equation (1) above.

The wireless device 235 may then obtain 712 amplitude compensation factors 122 using the amplitude imbalance 114. The wireless device 235 may apply 714 the amplitude compensation factors 122 in the Tx I/Q imbalance compensation module 120 to reduce the Tx I/Q amplitude imbalance 114. The wireless device 235 may apply 716 a known phase imbalance. The wireless device 235 may then transmit 718 a complex tone at the calibration frequency. The wireless device 235 may capture 720 the complex tone in the Rx digital front-end (DFE) memory. The wireless device 235 may normalize 722 the stored complex tone by calculating the root mean square (RMS) of the stored complex tone.

The wireless device 235 may calculate 728 the root mean square (RMS) of the inphase signal and the root mean square (RMS) of the quadrature signal. The wireless device 235 may then determine 730 whether the ratio of the inphase signal to the quadrature signal is equal to 1 as illustrated in Equation (10):

$${α}_{Tx}^{′} = \sqrt{\frac{{\int }_{0}^{T} ℜ {\{ y ( t ) {e}^{- j {ϕ}_{n}^{′}} \}}^{2} d t}{{\int }_{0}^{T} {\{ y ( t ) {e}^{- j {ϕ}_{n}^{′}} \}}^{2} d t}} -> 1 {\vert}_{{ϕ}_{n}^{′} -> {ϕ}_{n}} . \qquad ( 10 )$$

In Equation (10), the real parts of the captured complex tone are in the numerator and the imaginary parts of the captured complex tone are in the denominator. In other words, Equation (10) is used to determine whether the root mean square (RMS) of the real and imaginary parts of the captured complex tone are equal. If the real and imaginary parts of the captured complex tone aren't equal, it is known that the loopback phase needs to be adjusted. This loopback phase adjustment may be performed on the captured data, thus eliminating the need to recapture the data. In Equation (10), φₙ is the loopback phase for capture n, φ′ₙ is the incremental loopback phase correction for capture n and α′_{Tx} is the incremental amplitude ratio due to the loopback phase and the estimated phase imbalance 116. Equation (10) uses a brute-force determination of the loopback phase based on the amplitude imbalance 114 having been corrected (i.e., the amplitude ratio of the I and Q signals is equal to 1). The ratio in Equation (10) can go to 1 with multiple different phases, resulting in phase sign ambiguity.

If the ratio of the root mean square (RMS) of the inphase signal to the root mean square (RMS) of the quadrature signal is not equal to 1, the wireless device 235 may apply 732 a phase shift and again calculate 728 the root mean square (RMS) of the inphase signal and the root mean square (RMS) of the quadrature signal. If the ratio of the root mean square (RMS) of the inphase signal to the root mean square (RMS) of the quadrature signal is equal to 1, the wireless device 235 may calculate 731 the estimated Tx I/Q phase imbalance φ_{Tx} 116 using Equation (11):

$${φ}_{Tx} = {sin}^{- 1} ( - \frac{2}{T} {\int }_{0}^{T} {{y}^{\hat{\hat{}}}}_{I} ( t ) {{y}^{\hat{\hat{}}}}_{Q} ( t ) d t ) . \qquad ( 11 )$$

In Equation (11), \hat{ŷ}(t) is the loopback phase corrected inphase data normalized to the complex signal root mean square (RMS), \hat{ŷ}_{Q}(t) is the loopback phase corrected Q data normalized to the complex signal root mean square (RMS) and φ_{Tx} is the estimated I/Q phase imbalance 116. The resulting estimated phase imbalance 116 of Equation (11) may have sign ambiguity that needs to be corrected using knowledge of the sign of the known artificial phase imbalance that is applied.

The wireless device 235 may remove 726 the known phase imbalance and obtain 734 phase compensation factors 124 using the estimated I/Q phase imbalance 116. The wireless device 235 may then remove 736 the estimated Tx I/Q phase imbalance 116 using the phase compensation factors 124. In other words, the wireless device 235 may apply the phase compensation factors 124 to signals in the transmitter 231 to remove 736 the estimated Tx I/Q phase imbalance 116.

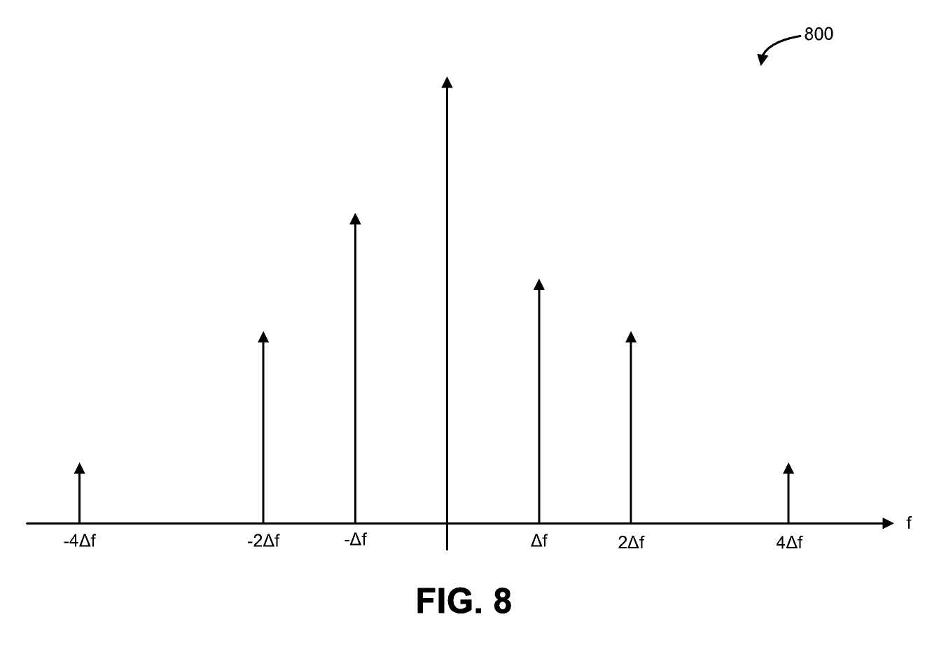

FIG. 8 is a graph 800 illustrating the result of mixing two local oscillators (LOs) with a Δf offset. The local oscillator (LO) offset plus or minus the calibration frequency must fall within the baseband filter bandwidth. A Tx/Rx local oscillator (LO) offset may be required for Tx I/Q imbalance estimation, due to the RF design (e.g., to minimize effects of second order intercept (IP2) and other harmonic distortion) and to eliminate the need to perform Rx I/Q imbalance estimation at the Tx local oscillator (LO) frequencies. The local oscillator (LO) offset (Δf=f_{Tx}−f_{Rx}) may be determined such that the high order product terms and signal mixing with high order products do not interfere with the image or tone. Due to the local oscillators (LOs) not being pure sinusoids, tones at multiples of the Δf offset result.

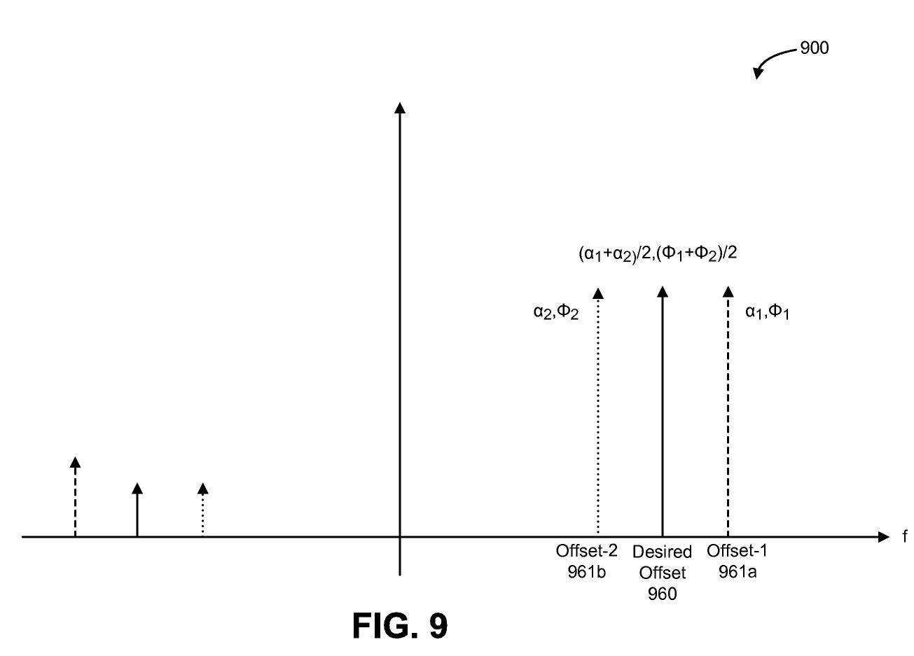

FIG. 9 is a graph 900 illustrating I/Q imbalance estimates and estimate interpolation. For high image rejection, I/Q imbalance needs to be estimated at the given frequency offset, due to frequency dependency. Estimation at arbitrary offsets may be undesirable. Estimates may be generalized to apply to multiple local oscillators (LOs), offsets, gain settings, etc. In one configuration, this generalization may include selecting the closest estimate (e.g., the offset-1 961a or the offset-2 961b) to the desired offset 960. In another configuration, this generalization may include interpolating estimates. Other generalizations may also be used. Some loss in the image rejection may occur as a result of the generalization.

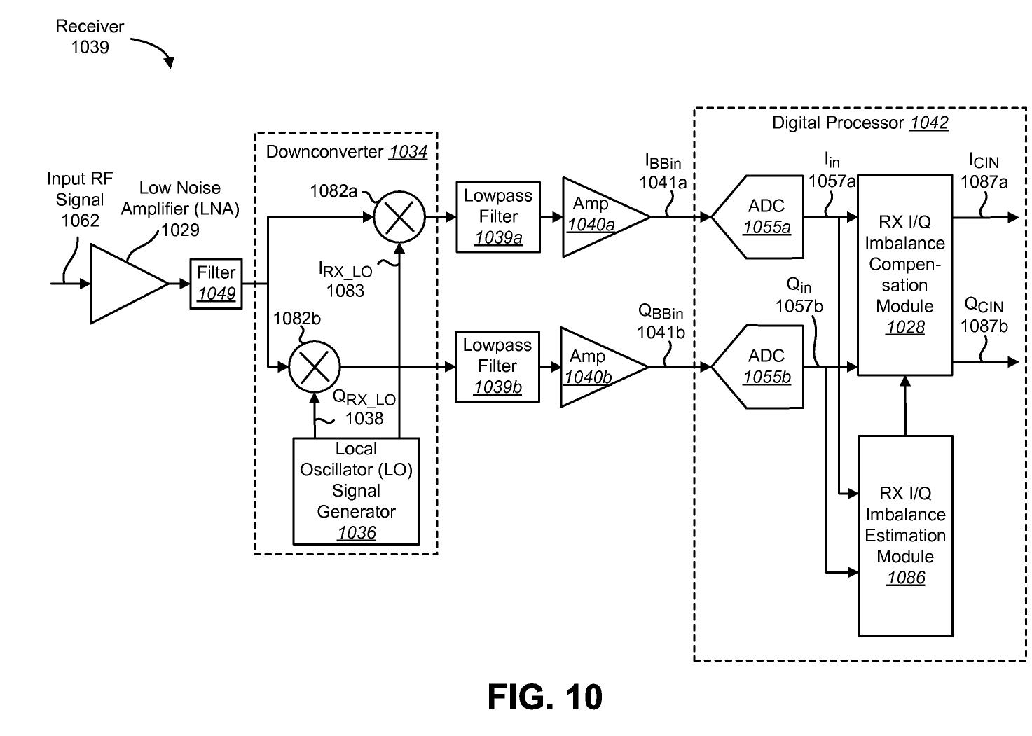

FIG. 10 is a block diagram illustrating a receiver 1039 configured for I/Q imbalance estimation and compensation. The receiver 1039 may be part of a transceiver 233 on a wireless device 235. The receiver 1039 may include a low noise amplifier (LNA) 1029 that receives an input RF signal 1062. The output of the low noise amplifier (LNA) 1029 may be passed through a filter 1049 and then passed through a downconverter 1034. The downconverter 1034 may include a mixer 1082a for the inphase chain and a mixer 1082b for the quadrature chain. The mixer 1082a for the inphase chain may receive an inphase receive (Rx) local oscillator (LO) signal I_{Rx}_{_{—}}_{LO} 1083 from a local oscillator (LO) signal generator 1036. The mixer 1082b for the quadrature chain may receive a quadrature receive (Rx) local oscillator (LO) signal Q_{Rx}_{_{—}}_{LO} 1038 from the local oscillator (LO) signal generator 1036.

The output of the mixer 1082a for the inphase chain may be passed through a lowpass filter 1039a and an amplifier 1040a before being input to a digital processor 1042 as a baseband inphase receive signal I_{BBin} 1041a. Likewise, the output of the mixer 1082b for the quadrature chain may be passed through a lowpass filter 1039b and an amplifier 1040b before being input to the digital processor 1042 as a baseband quadrature receive signal Q_{BBin} 1041b. The digital processor 1042 may include an analog-to-digital converter (ADC) 1055a for the inphase chain, an analog-to-digital converter (ADC) 1055b for the quadrature chain, an Rx I/Q imbalance estimation module 1086 and an Rx I/Q imbalance compensation module 1028. The analog-to-digital converter (ADC) 1055a for the inphase chain may output a digital inphase input signal Iᵢₙ 1057a to the Rx I/Q imbalance estimation module 1086 and to the Rx I/Q imbalance compensation module 1028. Likewise, the analog-to-digital converter (ADC) 1055b for the quadrature chain may output a digital quadrature input signal Qᵢₙ 1057b to the Rx I/Q imbalance estimation module 1086 and to the Rx I/Q imbalance compensation module 1028.

The Rx I/Q imbalance estimation module 1086 may determine an amplitude imbalance 185 and a phase imbalance 126 for the receiver 1039. The Rx I/Q imbalance estimation module 1086 may send the amplitude imbalance 185 and the phase imbalance 126 to the Rx I/Q imbalance compensation module 1028. The Rx I/Q imbalance compensation module 1028 may use the amplitude imbalance 185 to generate and apply amplitude compensation factors 130 to the digital inphase input signal Iᵢₙ 1057a and the digital quadrature input signal Qᵢₙ 1057b. The Rx I/Q imbalance compensation module 1028 may use the phase imbalance 126 to generate and apply phase compensation factors 132 to the digital inphase input signal Iᵢₙ 1057a and the digital quadrature input signal Qᵢₙ 1057b. The Rx I/Q imbalance compensation module 1028 may output a compensated inphase signal I_{CIN} 1087a and a compensated quadrature signal Q_{CIN} 1087b.

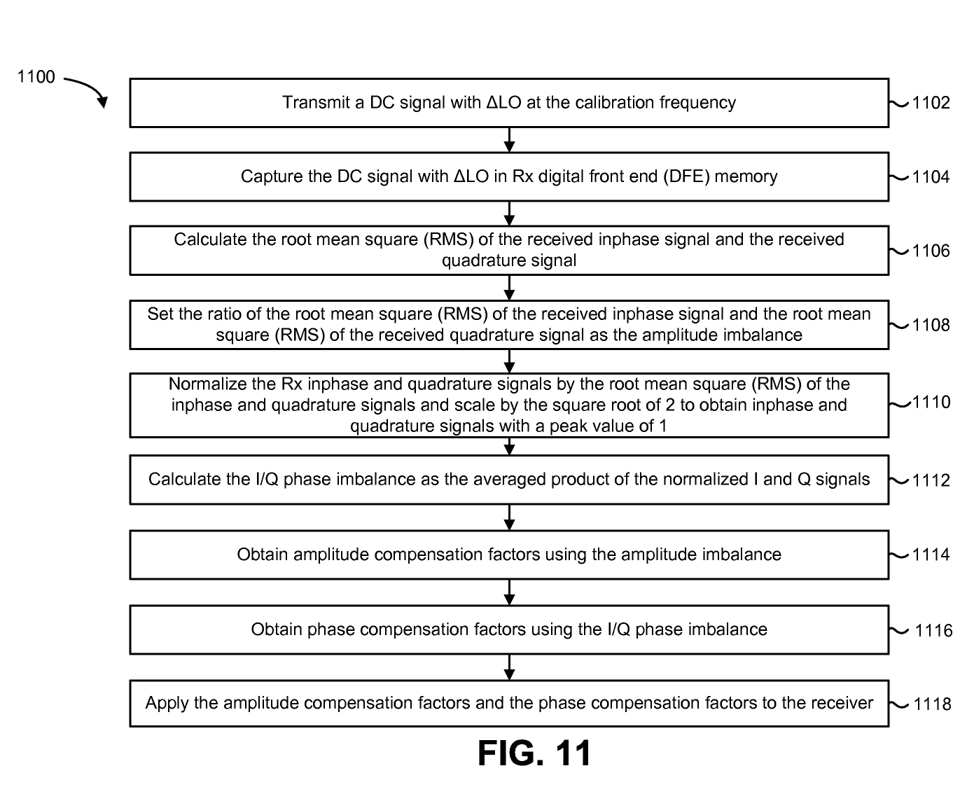

FIG. 11 is a flow diagram of a method 1100 for calibrating an I/Q imbalance module 110 to reduce Rx I/Q imbalance. The method 1100 may be performed by a wireless device 235 such as a base station 102 or a wireless communication device 104. The wireless device 235 may transmit 1102 a DC signal with ΔLO at the calibration frequency. The wireless device 235 may capture 1104 the DC signal with ΔLO in Rx digital front-end (DFE) memory. The wireless device 235 may calculate 1106 the root mean square (RMS) of the received inphase signal and the received quadrature signal.

The wireless device 235 may set 1108 the ratio of the root mean square (RMS) of the received inphase signal and the root mean square (RMS) of the quadrature signal as the amplitude imbalance 185 using Equation (12):

$${α}_{Rx} = \sqrt{\frac{{\int }_{0}^{T} ℜ {\{ y ( t ) \}}^{2} d t}{{\int }_{0}^{T} {\{ y ( t ) \}}^{2} d t}} . \qquad ( 12 )$$

In Equation (12), y(t) is the received signal and α_{Rx} is the Rx I/Q amplitude imbalance 185. The root mean square (RMS) may be calculated on the real and imaginary parts of the received complex waveform. The wireless device 235 may normalize 1110 the Rx inphase and quadrature signals by the root mean square (RMS) of the inphase and quadrature signals and scale by the square root of 2 to obtain inphase and quadrature signals with a peak value of 1. The wireless device 235 may calculate 1112 the Rx I/Q phase imbalance 126 as the averaged product of the normalized inphase and quadrature signals using Equation (13):

$${φ}_{Rx} = {sin}^{- 1} ( - \frac{2}{T} {\int }_{0}^{T} {\hat{y}}_{I} ( t ) {\hat{y}}_{Q} ( t ) d t ) . \qquad ( 13 )$$

In Equation (13), ŷ_{I}(t) is the real part of the received signal normalized to peak 1, ŷ_{Q}(t) is the imaginary part of the received signal normalized to peak 1 and φ_{Rx} is the Rx I/Q phase imbalance 126. The wireless device 235 may obtain 1114 amplitude compensation factors 130 using the amplitude imbalance 185. The wireless device 235 may also obtain 1116 phase compensation factors 132 using the I/Q phase imbalance 126. The wireless device 235 may then apply 1118 the amplitude compensation factors 130 and the phase compensation factors 132 to the receiver 1039.

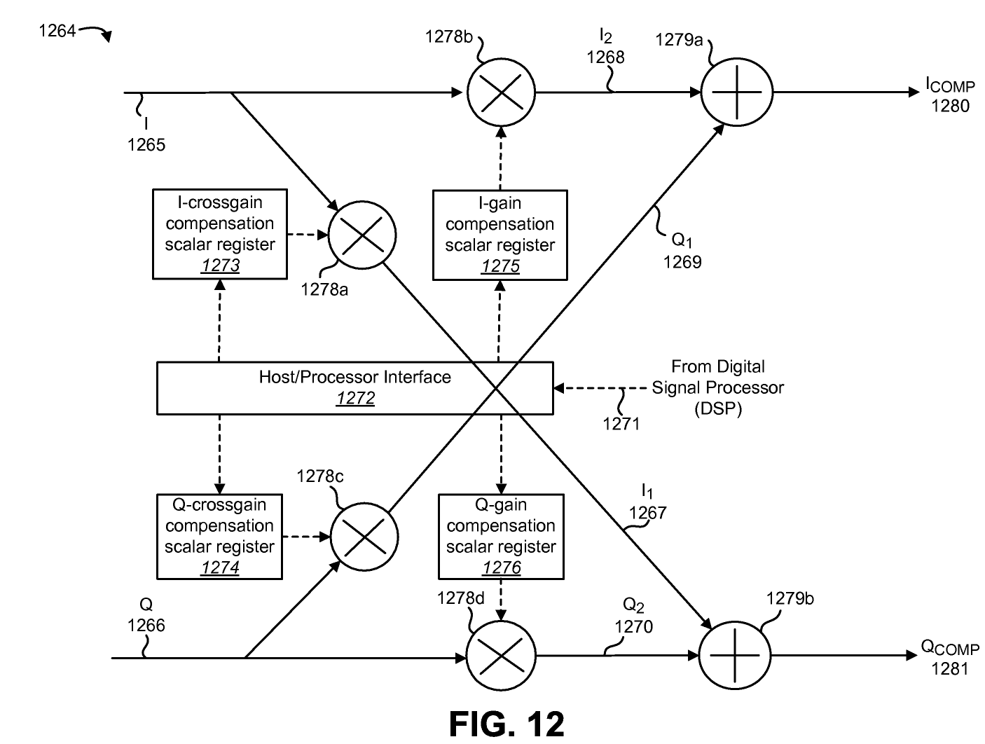

FIG. 12 is a block diagram illustrating an I/Q imbalance compensation circuit 1264. The I/Q imbalance compensation circuit 1264 may be used in either the Tx I/Q imbalance compensation module 120 or the Rx I/Q imbalance compensation module 128. The I/Q imbalance compensation circuit 1264 may receive an uncompensated inphase signal 11265 and an uncompensated quadrature signal Q 1266. The I/Q imbalance compensation circuit 1264 may include a host/processor interface 1272. The host/processor interface 1272 may receive instructions 1271 from the digital signal processor (DSP) (such as the amplitude compensation factors or the phase compensation factors).

The host/processor interface 1272 may control an I-crossgain compensation scalar register 1273, an I-gain compensation scalar register 1275, a Q-crossgain compensation scalar register 1274 and a Q-gain compensation scalar register 1276. A first mixer 1278a may mix the uncompensated inphase signal 11265 with the output of the I-crossgain compensation scalar register 1273 to obtain an I1 signal 1267. A second mixer 1278b may mix the uncompensated inphase signal 11265 with the output of the I-gain compensation scalar register 1275 to obtain an I2 signal 1268. A third mixer 1278c may mix the uncompensated quadrature signal Q 1266 with the output of the Q-crossgain compensation scalar register 1274 to obtain a Q1 signal 1269. A fourth mixer 1278d may mix the uncompensated quadrature signal Q 1266 with the output of the Q-gain compensation scalar register 1276 to obtain a Q2 signal 1270.

The Q1 signal 1269 may be combined with the I2 signal 1268 in a first adder 1279a to obtain the compensated inphase signal I_{COMP} 1280. The I1 signal 1267 may be combined with the Q2 signal 1270 in a second adder 1279b to obtain the compensated quadrature signal Q_{COMP} 1281. The I/Q imbalance compensation circuit 1264 may also be used for debugging and swapping the inphase and quadrature branches.

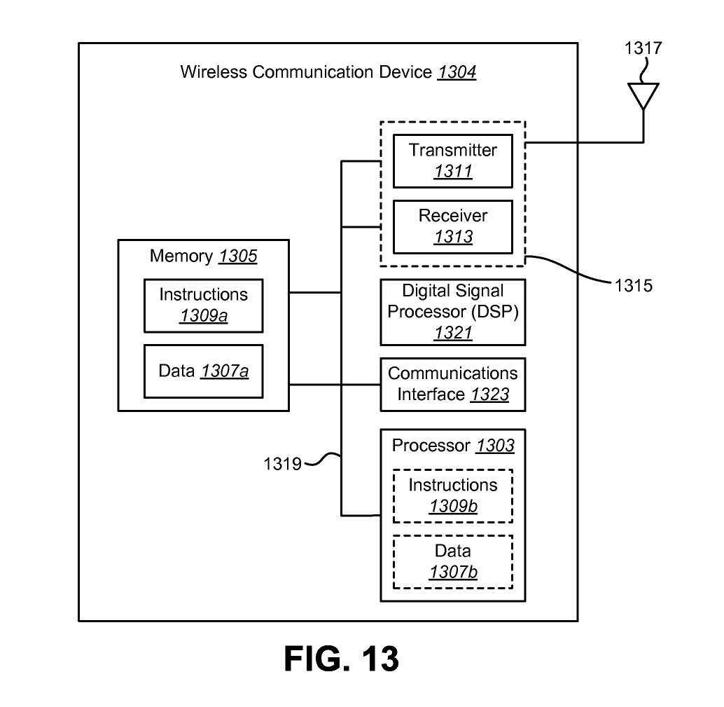

FIG. 13 illustrates certain components that may be included within a wireless communication device 1304. The wireless communication device 1304 may be an access terminal, a mobile station, a user equipment (UE), etc. The wireless communication device 1304 includes a processor 1303. The processor 1303 may be a general purpose single- or multi-chip microprocessor (e.g., an ARM), a special purpose microprocessor (e.g., a digital signal processor (DSP)), a microcontroller, a programmable gate array, etc. The processor 1303 may be referred to as a central processing unit (CPU). Although just a single processor 1303 is shown in the wireless communication device 1304 of FIG. 13, in an alternative configuration, a combination of processors (e.g., an ARM and DSP) could be used.

The wireless communication device 1304 also includes memory 1305. The memory 1305 may be any electronic component capable of storing electronic information. The memory 1305 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1307a and instructions 1309a may be stored in the memory 1305. The instructions 1309a may be executable by the processor 1303 to implement the methods disclosed herein. Executing the instructions 1309a may involve the use of the data 1307a that is stored in the memory 1305. When the processor 1303 executes the instructions 1309a, various portions of the instructions 1309b may be loaded onto the processor 1303, and various pieces of data 1307b may be loaded onto the processor 1303.

The wireless communication device 1304 may also include a transmitter 1311 and a receiver 1313 to allow transmission and reception of signals to and from the wireless communication device 1304. The transmitter 1311 and receiver 1313 may be collectively referred to as a transceiver 1315. An antenna 1317 may be electrically coupled to the transceiver 1315. The wireless communication device 1304 may also include (not shown) multiple transmitters, multiple receivers, multiple transceivers and/or multiple antennas.

The wireless communication device 1304 may include a digital signal processor (DSP) 1321. The wireless communication device 1304 may also include a communications interface 1323. The communications interface 1323 may allow a user to interact with the wireless communication device 1304.

The various components of the wireless communication device 1304 may be coupled together by one or more buses, which may include a power bus, a control signal bus, a status signal bus, a data bus, etc. For the sake of clarity, the various buses are illustrated in FIG. 13 as a bus system 1319.

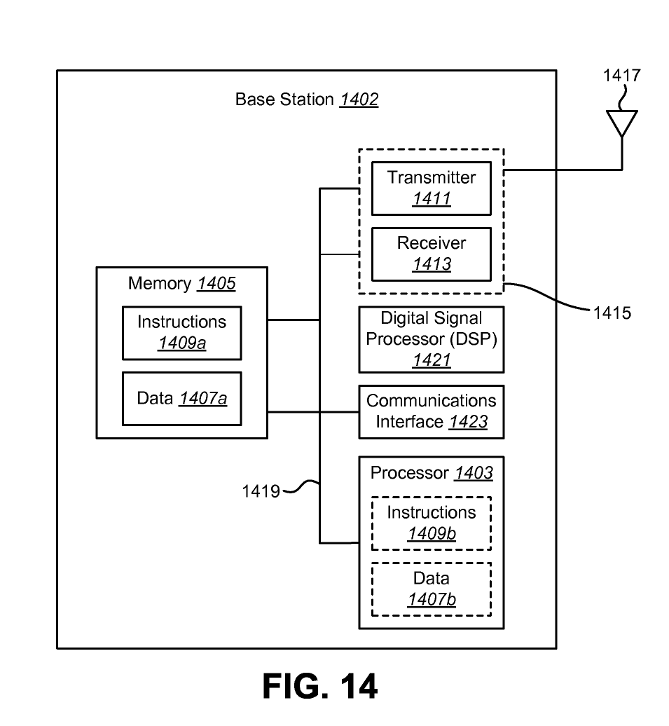

FIG. 14 illustrates certain components that may be included within a base station 1402. A base station 1402 may also be referred to as, and may include some or all of the functionality of, an access point, a broadcast transmitter, a NodeB, an evolved NodeB, etc. The base station 1402 includes a processor 1403. The processor 1403 may be a general purpose single- or multi-chip microprocessor (e.g., an ARM), a special purpose microprocessor (e.g., a digital signal processor (DSP)), a microcontroller, a programmable gate array, etc. The processor 1403 may be referred to as a central processing unit (CPU). Although just a single processor 1403 is shown in the base station 1402 of FIG. 14, in an alternative configuration, a combination of processors (e.g., an ARM and DSP) could be used.

The base station 1402 also includes memory 1405. The memory 1405 may be any electronic component capable of storing electronic information. The memory 1405 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1407a and instructions 1409a may be stored in the memory 1405. The instructions 1409a may be executable by the processor 1403 to implement the methods disclosed herein. Executing the instructions 1409a may involve the use of the data 1407a that is stored in the memory 1405. When the processor 1403 executes the instructions 1409a, various portions of the instructions 1409b may be loaded onto the processor 1403, and various pieces of data 1407b may be loaded onto the processor 1403.

The base station 1402 may also include a transmitter 1411 and a receiver 1413 to allow transmission and reception of signals to and from the base station 1402. The transmitter 1411 and receiver 1413 may be collectively referred to as a transceiver 1415. An antenna 1417 may be electrically coupled to the transceiver 1415. The base station 1402 may also include (not shown) multiple transmitters, multiple receivers, multiple transceivers and/or additional antennas.

The base station 1402 may include a digital signal processor (DSP) 1421. The base station 1402 may also include a communications interface 1423. The communications interface 1423 may allow a user to interact with the base station 1402.

The various components of the base station 1402 may be coupled together by one or more buses, which may include a power bus, a control signal bus, a status signal bus, a data bus, etc. For the sake of clarity, the various buses are illustrated in FIG. 14 as a bus system 1419.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4, 6, 7 and 11, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for a self-calibrating reduction in inphase/quadrature imbalance, comprising:
calculating an inphase/quadrature amplitude imbalance;
applying a correction to the inphase/quadrature amplitude imbalance;
calculating an estimated inphase/quadrature phase imbalance, wherein
calculating an estimated inphase/quadrature phase imbalance comprises
calculating a loopback phase; and
applying a correction to the estimated inphase/quadrature phase imbalance.

2. The method of claim 1, wherein the inphase/quadrature imbalance is in a transmitter, and wherein the estimated inphase/quadrature phase imbalance is an estimated Tx inphase/quadrature phase imbalance.

3. The method of claim 2, wherein calculating an inphase/quadrature amplitude imbalance comprises:
transmitting an inphase-only tone at a calibration frequency;
capturing the inphase-only tone in Rx digital front end memory;
transmitting a quadrature-only tone at the calibration frequency;
capturing the quadrature-only tone in the Rx digital front end memory; and
calculating a ratio of a root mean square of a complex signal from the stored inphase-only tone and the stored quadrature-only tone to obtain the inphase/quadrature amplitude imbalance.

4. The method of claim 3, further comprising obtaining amplitude compensation factors using the amplitude imbalance, wherein applying a correction to the inphase/quadrature amplitude imbalance comprises applying the amplitude compensation factors to signals in the transmitter.

5. The method of claim 2, wherein calculating an estimated inphase/quadrature phase imbalance further comprises applying a known phase imbalance.

6. The method of claim 2, wherein calculating an estimated inphase/quadrature phase imbalance further comprises:
transmitting a complex tone at a calibration frequency;
capturing the complex tone in Rx digital front end memory; and
calculating an inphase and quadrature difference term and an inphase and quadrature product term from the stored complex tone, wherein the loopback phase is calculated using the inphase and quadrature difference term and the inphase and quadrature product term.

7. The method of claim 6, wherein calculating an estimated inphase/quadrature phase imbalance further comprises normalizing the stored complex tone by calculating the root mean square of the stored complex tone.

8. The method of claim 6, wherein calculating an estimated inphase/quadrature phase imbalance further comprises:
determining that a sign of the estimated inphase/quadrature phase imbalance does not correspond to the known phase imbalance; and
flipping the sign of the estimated inphase/quadrature phase imbalance.

9. The method of claim 6, wherein calculating an estimated inphase/quadrature phase imbalance further comprises:
applying a known phase imbalance, and
calculating the estimated inphase/quadrature phase imbalance as the inphase and quadrature product term normalized by the cosine of the loopback phase, wherein applying a correction to the estimated inphase/quadrature phase imbalance comprises:
removing the known phase imbalance;
obtaining phase compensation factors using the estimated inphase/quadrature phase imbalance; and
removing the estimated inphase/quadrature phase imbalance using the phase compensation factors.

10. The method of claim 9, wherein removing the estimated inphase/quadrature phase imbalance using the phase compensation factors comprises applying the phase compensation factors to signals in the transmitter.

11. The method of claim 2, wherein calculating an estimated inphase/quadrature phase imbalance further comprises:
transmitting a complex tone at a calibration frequency;
capturing the complex tone in Rx digital front end memory;
calculating a root mean square of an inphase signal and a root mean square of a quadrature signal; and
determining whether to adjust the loopback phase by determining whether a ratio of the root mean square of the inphase signal to the root mean square of the quadrature signal is equal to one.

12. The method of claim 11, wherein the ratio of the root mean square of the inphase signal to the root mean square of the quadrature signal is not equal to one, and wherein calculating an estimated inphase/quadrature phase imbalance further comprises:
applying a phase shift to adjust the loopback phase; and
recalculating the root mean square of the inphase signal and the root mean square of the quadrature signal.

13. The method of claim 11, wherein the ratio of the root mean square of the inphase signal to the root mean square of the quadrature signal is equal to one, wherein calculating an estimated inphase/quadrature phase imbalance further comprises:
applying a known phase imbalance prior to transmitting the complex tone; and
removing the known phase imbalance, and wherein applying a correction to the estimated inphase/quadrature phase imbalance comprises:
obtaining phase compensation factors using the estimated inphase/quadrature phase imbalance; and
removing the estimated inphase/quadrature phase imbalance using the phase compensation factors.

14. The method of claim 13, wherein removing the estimated inphase/quadrature phase imbalance using the phase compensation factors comprises applying the phase compensation factors to signals in the transmitter.

15. The method of claim 1, wherein the inphase/quadrature imbalance is in a receiver.

16. The method of claim 15, wherein calculating an inphase/quadrature amplitude imbalance comprises:
transmitting a DC signal with a shifted local oscillator at a calibration frequency;
capturing the DC signal with the shifted local oscillator in Rx digital front end memory; and
setting a ratio of a root mean square of a received inphase signal and a root mean square of a received quadrature signal as the inphase/quadrature amplitude imbalance.

17. The method of claim 16, wherein calculating an inphase/quadrature amplitude imbalance further comprises obtaining amplitude compensation factors using the amplitude imbalance, and wherein applying a correction to the estimated inphase/quadrature amplitude imbalance comprises applying the amplitude compensation factors to signals in the receiver.

18. The method of claim 15, wherein calculating an estimated inphase/quadrature phase imbalance comprises:
transmitting a DC signal with a shifted local oscillator at a calibration frequency;
capturing the DC signal with the shifted local oscillator in Rx digital front end memory;
normalizing an Rx inphase signal and an Rx quadrature signal by a root mean square of the inphase and quadrature signals;
scaling the normalized Rx inphase signal and the normalized Rx quadrature signal by the square root of two; and
calculating the phase imbalance as the averaged product of the scaled normalized Rx inphase signal and the scaled normalized Rx quadrature signal.

19. The method of claim 18, wherein calculating an estimated inphase/quadrature phase imbalance further comprises obtaining phase compensation factors using the inphase/quadrature phase imbalance, and wherein applying a correction to the inphase/quadrature phase imbalance comprises applying the phase compensation factor to signals in the receiver.

20. The method of claim 1, wherein the method is performed by a digital processor in a wireless device.

21. The method of claim 20, wherein the wireless device is a wireless communication device.

22. The method of claim 20, wherein the wireless device is a base station.

23. The method of claim 20, wherein the method is self-calibrating within the wireless device.

24. The method of claim 1, wherein the inphase/quadrature imbalance is estimated during warm-up while temperatures are being monitored, allowing the building of a temperature dependent inphase/quadrature imbalance compensation table.

25. The method of claim 1, wherein the inphase/quadrature imbalance is re-estimated when large temperature changes are likely to be detected, allowing the building of a temperature dependent inphase/quadrature imbalance compensation table.

26. The method of claim 1, wherein calculating an estimated inphase/quadrature phase imbalance comprises interpolating multiple estimated inphase/quadrature phase imbalances.

27. The method of claim 1, wherein calculating an estimated inphase/quadrature amplitude imbalance comprises interpolating multiple estimated inphase/quadrature amplitude imbalances.

28. The method of claim 1, further comprising selecting a local oscillator offset such that high order product terms and signal mixing with high order products do not interfere with an image or tone.

29. The method of claim 1, wherein a configurable Rx filter is used to improve the accuracy of the calculation of the estimated inphase/quadrature phase imbalance.

30. A wireless device configured for a self-calibrating reduction in inphase/quadrature imbalance, comprising:
a processor;
memory in electronic communication with the processor;
instructions stored in the memory, the instructions being executable by the processor to:
calculate an inphase/quadrature amplitude imbalance;
apply a correction to the inphase/quadrature amplitude imbalance;
calculate an estimated inphase/quadrature phase imbalance, wherein the instructions executable to calculate an estimated inphase/quadrature phase imbalance comprise instructions executable to calculate a loopback phase; and
apply a correction to the inphase/quadrature amplitude imbalance.

31. The wireless device of claim 30, wherein the inphase/quadrature imbalance is in a transmitter, and wherein the estimated inphase/quadrature phase imbalance is an estimated Tx inphase/quadrature phase imbalance.

32. The wireless device of claim 31, wherein the instructions executable to calculate an inphase/quadrature amplitude imbalance comprise instructions executable to:
transmit an inphase-only tone at a calibration frequency;
capture the inphase-only tone in Rx digital front end memory;
transmit a quadrature-only tone at the calibration frequency;
capture the quadrature-only tone in the Rx digital front end memory; and
calculate a ratio of a root mean square of a complex signal from the stored inphase-only tone and the stored quadrature-only tone to obtain the inphase/quadrature amplitude imbalance.

33. The wireless device of claim 32, wherein the instructions are further executable to obtain amplitude compensation factors using the amplitude imbalance, wherein the instructions executable to apply a correction to the inphase/quadrature amplitude imbalance comprise instructions executable to apply the amplitude compensation factors to signals in the transmitter.

34. The wireless device of claim 31, wherein the instructions executable to calculate an estimated inphase/quadrature phase imbalance comprise instructions executable to apply a known phase imbalance.

35. The wireless device of claim 31, wherein the instructions executable to calculate an estimated inphase/quadrature phase imbalance further comprise instructions executable to:
transmit a complex tone at a calibration frequency;
capture the complex tone in Rx digital front end memory; and
calculate an inphase and quadrature difference term and an inphase and quadrature product term from the stored complex tone, wherein the loopback phase is calculated using the inphase and quadrature difference term and the inphase and quadrature product term.

36. The wireless device of claim 35, wherein the instructions executable to calculate an estimated inphase/quadrature phase imbalance further comprise instructions executable to normalize the stored complex tone by calculating the root mean square of the stored complex tone.

37. The wireless device of claim 35, wherein the instructions executable to calculate an estimated inphase/quadrature phase imbalance further comprise instructions executable to:
determine that a sign of the estimated inphase/quadrature phase imbalance does not correspond to the known phase imbalance; and
flip the sign of the estimated inphase/quadrature phase imbalance.

38. The wireless device of claim 35, wherein the instructions executable to calculate an estimated inphase/quadrature phase imbalance further comprise instructions executable to:
apply a known phase imbalance; and
calculate the estimated inphase/quadrature phase imbalance as the inphase and quadrature product term normalized by the cosine of the loopback phase, wherein the instructions executable to apply a correction to the estimated inphase/quadrature phase imbalance comprise instructions executable to:
remove the known phase imbalance;
obtain phase compensation factors using the estimated inphase/quadrature phase imbalance; and
remove the estimated inphase/quadrature phase imbalance using the phase compensation factors.

39. The wireless device of claim 38, wherein the instructions executable to remove the estimated inphase/quadrature phase imbalance using the phase compensation factors comprise instructions executable to apply the phase compensation factors to signals in the transmitter.

40. The wireless device of claim 31, wherein the instructions executable to calculate an estimated inphase/quadrature phase imbalance further comprise instructions executable to:
transmit a complex tone at a calibration frequency;
capture the complex tone in Rx digital front end memory;
calculate a root mean square of a inphase signal and a root mean square of a quadrature signal; and
determine whether to adjust the loopback phase by determining whether a ratio of the root mean square of the inphase signal to the root mean square of the quadrature signal is equal to one.

41. The wireless device of claim 40, wherein the ratio of the root mean square of the inphase signal to the root mean square of the quadrature signal is not equal to one, and wherein the instructions executable to calculate an estimated inphase/quadrature phase imbalance further comprise instructions executable to:
apply a phase shift to adjust the loopback phase; and
recalculate the root mean square of the inphase signal and the root mean square of the quadrature signal.

42. The wireless device of claim 40, wherein the ratio of the root mean square of the inphase signal to the root mean square of the quadrature signal is equal to one, wherein the instructions executable to calculate an estimated inphase/quadrature phase imbalance further comprise instructions executable to:
apply a known phase imbalance prior to transmitting the complex tone; and
remove the known phase imbalance, and wherein the instructions executable to apply a correction to the estimated inphase/quadrature phase imbalance comprise instructions executable to:
obtain phase compensation factors using the estimated inphase/quadrature phase imbalance; and
remove the estimated inphase/quadrature phase imbalance using the phase compensation factors.

43. The wireless device of claim 42, wherein the instructions executable to remove the estimated inphase/quadrature phase imbalance using the phase compensation factors comprise instructions executable to apply the phase compensation factors to signals in the transmitter.

44. The wireless device of claim 30, wherein the inphase/quadrature imbalance is in a receiver.

45. The wireless device of claim 44, wherein the instructions executable to calculate an inphase/quadrature amplitude imbalance comprise instructions executable to:
transmit a DC signal with a shifted local oscillator at a calibration frequency;
capture the DC signal with the shifted local oscillator in Rx digital front end memory; and
set a ratio of a root mean square of a received inphase signal and a root mean square of a received quadrature signal as the inphase/quadrature amplitude imbalance.

46. The wireless device of claim 45, wherein the instructions executable to calculate an inphase/quadrature amplitude imbalance further comprise instructions executable to obtain amplitude compensation factors using the amplitude imbalance, and wherein the instructions executable to apply a correction to the estimated inphase/quadrature amplitude imbalance comprise instructions executable to apply the amplitude compensation factors to signals in the receiver.

47. The wireless device of claim 44, wherein the instructions executable to calculate an estimated inphase/quadrature phase imbalance comprise instructions executable to:
transmit a DC signal with a shifted local oscillator at a calibration frequency;
capture the DC signal with the shifted local oscillator in Rx digital front end memory;
normalize an Rx inphase signal and an Rx quadrature signal by a root mean square of the inphase and quadrature signals;
scale the normalized Rx inphase signal and the normalized Rx quadrature signal by the square root of two; and
calculate the phase imbalance as the averaged product of the scaled normalized Rx inphase signal and the scaled normalized Rx quadrature signal.

48. The wireless device of claim 47, wherein the instructions executable to calculate an estimated inphase/quadrature phase imbalance comprise instructions executable to obtain phase compensation factors using the inphase/quadrature phase imbalance, and wherein the instructions executable to apply a correction to the inphase/quadrature phase imbalance comprise instructions executable to apply the phase compensation factor to signals in the receiver.

49. The wireless device of claim 48, wherein the wireless device is a wireless communication device.

50. The wireless device of claim 48, wherein the wireless device is a base station.

51. The wireless device of claim 48, wherein the wireless device is self-calibrating.

52. The wireless device of claim 30, wherein the inphase/quadrature imbalance is estimated during warm-up while temperatures are being monitored, allowing the building of a temperature dependent inphase/quadrature imbalance compensation table.

53. The wireless device of claim 30, wherein the inphase/quadrature imbalance is re-estimated when large temperature changes are likely to be detected, allowing the building of a temperature dependent inphase/quadrature imbalance compensation table.

54. The wireless device of claim 30, wherein the instructions executable to calculate an estimated inphase/quadrature phase imbalance comprise instructions executable to interpolate multiple estimated inphase/quadrature phase imbalances.

55. The wireless device of claim 30, wherein the instructions executable to calculate an estimated inphase/quadrature amplitude imbalance comprise instructions executable to interpolate multiple estimated inphase/quadrature amplitude imbalances.

56. The wireless device of claim 30, wherein the instructions are further executable to select a local oscillator offset such that high order product terms and signal mixing with high order products do not interfere with an image or tone.

57. The wireless device of claim 30, wherein a configurable Rx filter is used to improve the accuracy of the calculation of the estimated inphase/quadrature phase imbalance.

58. A wireless device configured for a self-calibrating reduction in inphase/quadrature imbalance, comprising:
means for calculating an inphase/quadrature amplitude imbalance;
means for applying a correction to the inphase/quadrature amplitude imbalance;
means for calculating an estimated inphase/quadrature phase imbalance, wherein the means for calculating an estimated inphase/quadrature phase imbalance comprise means for calculating a loopback phase; and
means for applying a correction to the inphase/quadrature amplitude imbalance.

59. A computer-program product for a self-calibration reduction in inphase/quadrature imbalance, the computer-program product comprising a non-transitory computer-readable medium having instructions thereon, the instructions comprising:
code for causing a wireless device to calculate an inphase/quadrature amplitude imbalance;
code for causing the wireless device to apply a correction to the inphase/quadrature amplitude imbalance;
code for causing the wireless device to calculate an inphase/quadrature phase imbalance, wherein calculating an estimated inphase/quadrature phase imbalance comprises calculating a loopback phase; and
code for causing the wireless device to apply a correction to the inphase/quadrature amplitude imbalance.
